(19) United States
(12) Patent Application Publication
(10) Pub. No.: US 2024/0314725 A1
(43) Pub. Date: Sep. 19, 2024

(54) SIDELINK AIDED TIME DIFFERENCE OF ARRIVAL BASED POSITIONING

(71) Applicant: QUALCOMM Incorporated, San Diego, CA (US)

(72) Inventors: Weimin DUAN, San Diego, CA (US); Alexandros MANOLAKOS, Escondido, CA (US); Hung Dinh LY, San Diego, CA (US); Jing LEI, San Diego, CA (US); Seyedkianoush HOSSEINI, San Diego, CA (US)

(21) Appl. No.: 18/575,993

(22) PCT Filed: Jul. 11, 2022
(86) PCT No.: PCT/US2022/036657

§ 371 Date: Jan. 2, 2024

(30) Foreign Application Priority Data
Aug. 10, 2021 (GR) 20210100547

(51) Int. Cl. H04W 64/00; H04L 5/00; H04W 92/18

(52) U.S. Cl. CPC H04W 64/00; H04L 5/0051; H04W 92/18

(57) ABSTRACT

Techniques are provided for sidelink aided time difference of arrival (TDOA) based positioning methods. An example method of determining a time difference of arrival value includes receiving a first reference signal at a first time, wherein the first reference signal is transmitted from a first wireless node using a first radio access link, receiving a. second reference signal at a second time, wherein the second reference signal is transmitted from a second wireless node using a second radio access link, receiving assistance data including at least a transmit delay time value based, on a time the first reference signal is received by the second wireless node, and a time the second reference signal is transmitted by the second wireless node, and determining the time difference of arrival value based at least in part on the first time, the second time and the transmit delay time value.

### CROSS-REFERENCE TO RELATED APPLICATION

This application claims the benefit of Greek patent Application 20210100547, filed Aug. 10, 2022, entitled “SIDELINK AIDED TIME DIFFERENCE OF ARRIVAL BASED POSITIONING.” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and a fifth-generation (5G) service (e.g., 5G New Radio (NR)). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, asset tracking, locating a friend or family member, etc. Existing positioning methods include methods based on measuring radio signals transmitted from a variety of devices including satellite vehicles and terrestrial radio sources in a wireless network such as base stations and access points. Further, the capabilities of UE's may vary and positioning methods may be based on the capabilities of the devices.

### SUMMARY

An example method of determining a time difference of arrival value according to the disclosure includes receiving a first reference signal at a first time, wherein the first reference signal is transmitted from a first wireless node using a first radio access link, receiving a second reference signal at a second time, wherein the second reference signal is transmitted from a second wireless node using a second radio access link, receiving assistance data including at least a transmit delay time value based on a time the first reference signal is received by the second wireless node, and a time the second reference signal is transmitted by the second wireless node, and determining the time difference of arrival value based at least in part on the first time, the second time and the transmit delay time value.

Implementations of such a method may include one or more of the following features. The first wireless node may be a base station and the first reference signal may be a downlink positioning reference signal. The second wireless node may be a user equipment and the second reference signal may be sidelink reference signal. The first radio access link may utilize a cellular wide area network technology, and the second radio access link may be based on a sidelink protocol. The cellular wide area network technology may include fifth generation new radio. Receiving the assistance data may include receiving one or more sidelink messages including the assistance data from the second wireless node. Receiving the assistance data may include receiving one or more messages including the assistance data from the first wireless node. The assistance data may include an estimated propagation time based on a distance between the first wireless node and the second wireless node, and determining the time difference of arrival value is based at least in part on the estimated propagation time. A location based at least in part on the time difference of arrival value may be determined.

An example method of providing sidelink assistance data according to the disclosure includes receiving a first reference signal at a first time, wherein the first reference signal is transmitted from a first wireless node using a first radio access link, transmitting a second reference signal at a second time using a second radio access link, determining a transmit delay time value based on the first time and the second time, and transmitting an indication of the transmit delay time value.

Implementations of such a method may include one or more of the following features. The first wireless node may be a base station and the first reference signal may be a downlink positioning reference signal. The second reference signal may be sidelink reference signal. The first wireless node may be a user equipment and the first reference signal may be a sidelink reference signal. The second reference signal may be an uplink sounding reference signal. The first radio access link may utilize a cellular wide area network technology, and the second radio access link may be based on a sidelink protocol. The cellular wide area network technology may include fifth generation new radio. Transmitting the indication of the transmit delay time value may include transmitting one or more sidelink messages including the transmit delay time value to a proximate user equipment Transmitting the indication of the transmit delay time value may include transmitting one or more uplink messages including the transmit delay time value to a base station.

An example method of determining a time difference of arrival value according to the disclosure includes receiving a first reference signal at a first time, wherein the first reference signal is transmitted from a first wireless node using a first radio access link, receiving a second reference signal at a second time, wherein the second reference signal is transmitted from a second wireless node, receiving assistance data including a transmit delay time value based on a time the second wireless node receives a third reference signal and a time the second wireless node transmits the second reference signal, wherein the third reference signal is transmitted from the first wireless node using a second radio access link, determining a sidelink delay time value based on a time the first wireless node transmits the first reference signal, and a time the first wireless node transmits the third reference signal, and determining a time difference of arrival based at least in part on the first time, the second time, the transmit delay time value, and the sidelink delay time value.

Implementations of such a method may include one or more of the following features. The first wireless node may be a user equipment and the first reference signal may be an uplink positioning reference signal. The second wireless node may be a user equipment and the second reference signal may be an uplink positioning reference signal. The third reference signal may be a sidelink reference signal. The first radio access link may utilize a cellular wide area network technology, and the second radio access link is based on a sidelink protocol. The cellular wide area network technology may include fifth generation new radio. Receiving the assistance data may include receiving one or more sidelink messages including the assistance data from the second wireless node. Receiving the assistance data may include receiving one or more messages including the assistance data from a network server. Determining the sidelink delay time value may include receiving one or more messages from the first wireless node. Determining the sidelink delay time value may include receiving one or more messages from a network server. A range to the second wireless node may be determined. A location of the first wireless node based at least in part on the time difference of arrival value may be determined.

Items and/or techniques described herein may provide one or more of the following capabilities, as well as other capabilities not mentioned. Wireless nodes, such as user equipment (UE) and base stations, may utilize sidelink signals from and to neighboring wireless nodes to assist in obtaining time difference of arrival measurements. In an example, a target UE and neighboring UEs may receive downlink reference signals from a base station. The neighboring UEs may be configured to transmit sidelink signals in response to receiving the downlink reference signals. The target UE may be configured to determine reference signal time differences based on receiving the downlink reference signal and the sidelink signals. In an example, the target UE may transmit an uplink reference signal to a base station, and sidelink signals to the neighboring UEs. The neighboring UEs may be configured to transmit uplink reference signals in response to receiving the sidelink signals from the target UE. The base station may determine reference signal time differences based on receiving the uplink reference signals from the target UE and the neighboring UEs. The time difference of arrival measurements are not dependent on a synchronized time across the wireless nodes. The accuracy of position estimates may be improved. The messaging overhead for uplink and downlink reference signal positioning may be reduced. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIGS. 5 and 6 are diagrams illustrating exemplary techniques for determining a position of a mobile device using information obtained from a plurality of base stations.

FIG. 7 is an example round trip message flow between a user equipment and a base station.

FIG. 8 is a block diagram of an example sidelink aided downlink time difference of arrival based positioning method.

FIG. 9 is a message timing diagram of an example sidelink aided downlink time difference of arrival based positioning method.

FIG. 10 is a block diagram of an example sidelink aided uplink time difference of arrival based positioning method.

FIG. 11 is a message timing diagram of an example sidelink aided uplink time difference of arrival based positioning method.

FIG. 12 is an example message flow diagram of a sidelink aided downlink time difference of arrival based positioning method.

FIG. 13 is an example message flow diagram of a sidelink aided uplink time difference of arrival based positioning method.

FIG. 14 is a block flow diagram of a method of determining a time difference of arrival in sidelink aided positioning.

FIG. 15 is a block flow diagram of a method of providing sidelink assistance data.

FIG. 16 is a block flow diagram of a method of determining a time difference of arrival in sidelink aided uplink positioning.

### DETAILED DESCRIPTION

Techniques are discussed herein for sidelink aided time difference of arrival (TDOA) based positioning methods. The ability of some user equipment (UE), such as reduced capability UEs (RedCap UE), limited bandwidth UEs, or other low-tier UEs, such as NR Light UEs, to detect or provide reference signals transmitted from, or transmitted to, non-serving base stations may be limited. The distance between the UE and the base station may further reduce the ability for the UE to communicate with distant stations. In general, the limitations of a RedCap UE may be based on limited bandwidth capabilities, a reduced number of receive (Rx) antennas, and/or limited baseband processing capabilities. These limitations may reduce the ability of a RedCap UE to detect positioning reference signals (PRS), or other reference signals, transmitted by non-serving stations. The transmit power of a RedCap UE may also be limited such that Sounding Reference Signals (SRS) for positioning may not be detected by a non-serving station. The sidelink aided positioning methods provided herein may reduce the impact of low quality PRS and/or SRS measurement from non-serving stations, and improve the reliability of RSTD based positioning.

In an embodiment, the sidelink assisted positioning methods may be used to mitigate the impact of synchronization errors across different wireless nodes in a communication network. For example, a first wireless node, such as a serving base station (gNB), may transmit PRS to other wireless nodes such as a RedCap UE and other UEs. The other UEs may have increased capabilities as compared to the RedCap UE, and the range between the transmitting wireless node and the other UEs is known. In response to receiving a PRS, the other UEs may be configured to transmit sidelink signals to the RedCap UE and signal a time delay based on a time difference between receiving the PRS and transmitting the sidelink signals. The RedCap UE may be configured to determine and report a RSTD based on the received PRS and the sidelink signals received from the other UEs. In an example, a RedCap UE may transmit SRS which may be received by a serving wireless node (e.g., gNB). The RedCap UE may also transmit sidelink signals to other UEs. The other UEs may have increased capabilities as compared to the RedCap UE and the range between each of the other UEs and the serving wireless node is known. The other UEs may transmit SRS and signal a time difference based on the time a sidelink signal is received from the RedCap UE and the time the SRS is transmitted. The serving wireless node, or other network server, may be configured to determine a RSTD for the RedCap UE based on the SRS received from the RedCap UE and the SRS received from the other UEs. These techniques and configurations are examples, and other techniques and configurations may be used.

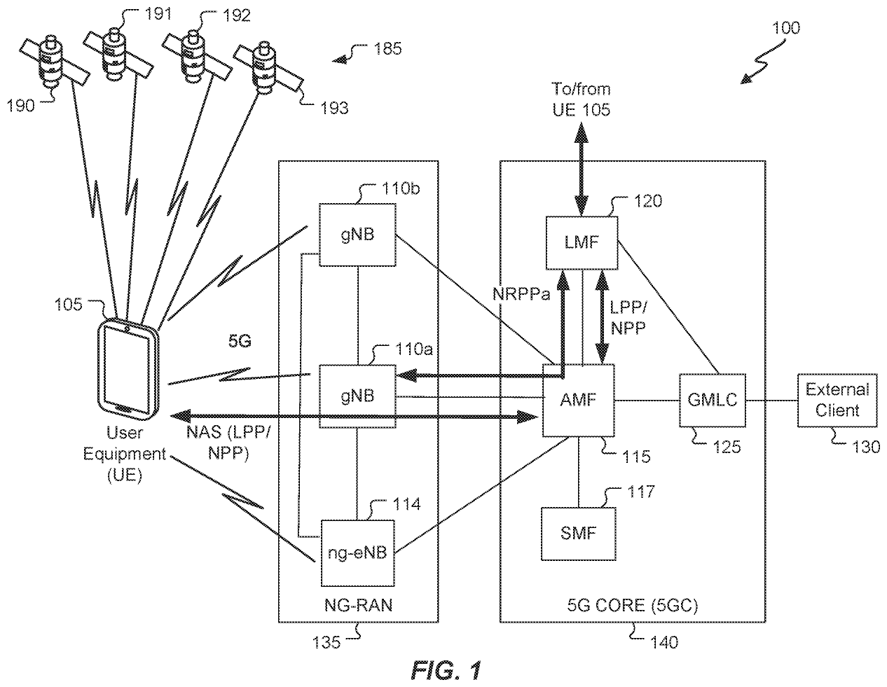

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114. AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G. Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a. 110b are examples and may, in various embodiments, be replaced by or include various other location server functionality and/or base station functionality respectively.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet. PDA, tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM). Code Division Multiple Access (CDMA). Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT) and/or radio access link, such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs, such as the gNB 110a, the gNB 110b, the ng-eNB 114, may each comprise one or more TRPs. For example, each sector within a cell of a BS may comprise a TRP, although multiple TRPs may share one or more components (e.g., share a processor but have separate antennas). The communication system 100 may include macro TRPs or the communication system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications. The LMF 120 may support positioning of the UE 105 when the UE 105 accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105. e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120).

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 37.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a. 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT). Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a. 110b, and/or the ng-eNB 114) or APs may obtain location measurements (e.g., measurements of RSSI, RTT, RSRP, RSRQ or Time Of Arrival (TOA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc. . . . that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a. 110b, the ng-eNB 114, etc.) to compute the UE's position.

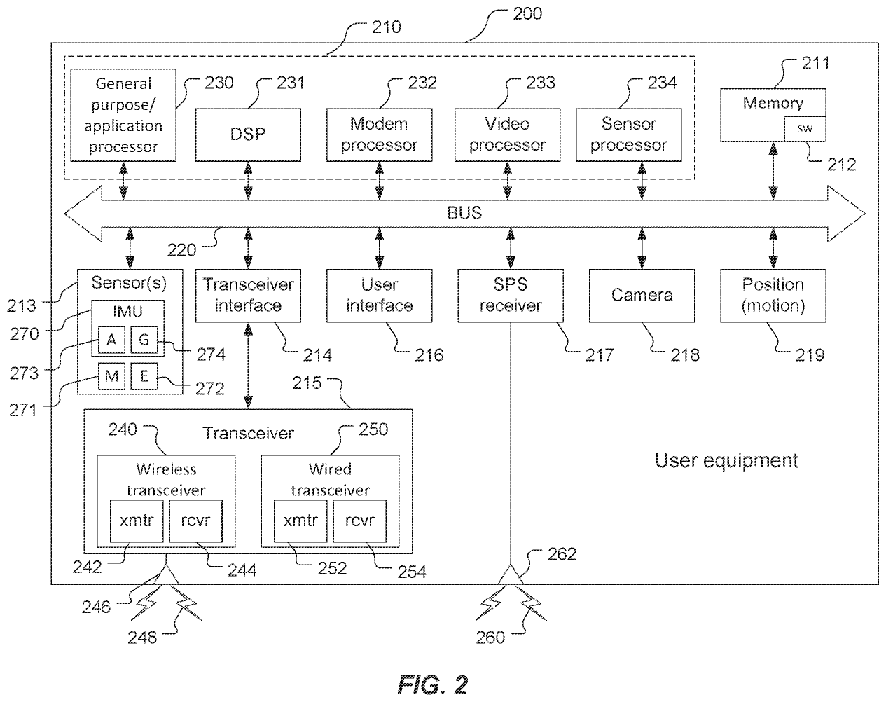

Referring also to FIG. 2, a UE 200 is an example of the UE 105 and comprises a computing platform including a processor 210, memory 211 including software (SW) 212, one or more sensors 213, a transceiver interface 214 for a transceiver 215 (that includes one or more wireless transceivers 240, and a wired transceiver 250), a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274. The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR). GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-Vehicle-to-Everything (V2X), PC5, IEEE 802.11 (including IEEE 802.11p). WiFi, WiFi Direct (WiFi-D). Bluetooth®, Zigbee etc. New Radio may use mm-wave frequencies and/or sub-6 GHZ frequencies. The wired transceiver 250 may include a transmitter 252 and a receiver 254 configured for wired communication, e.g., with the NG-RAN 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the wireless signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

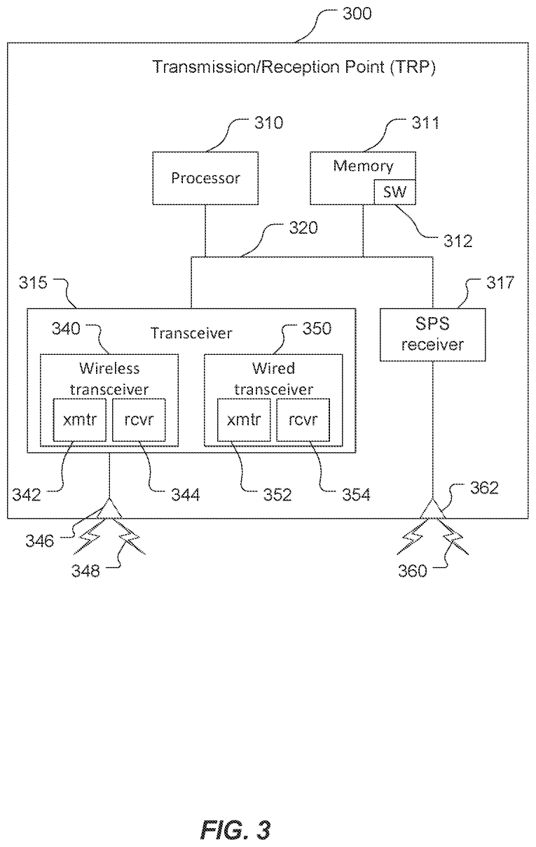

Referring also to FIG. 3, an example of a TRP 300 of the BSs (e.g., gNB 110a, gNB 110b, ng-eNB 114) comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices. e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the gNB 110a, gNB 110b, ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink or downlink channels, and/or one or more sidelink channels) and/or receiving (e.g., on one or more downlink or uplink channels, and/or one or more sidelink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System). AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured. e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

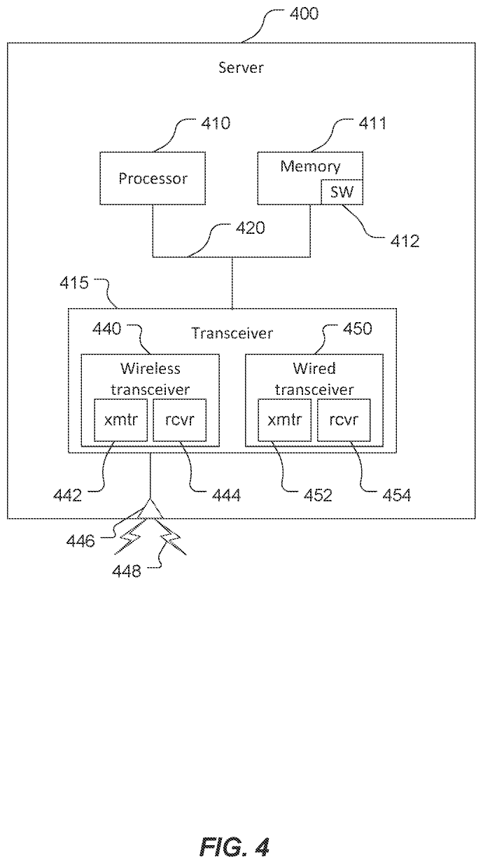

Referring also to FIG. 4, an example of the LMF 120 comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 (e.g., the LMF 120) performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more uplink channels) and/or receiving (e.g., on one or more downlink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System). AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p). WiFi, WiFi Direct (WiFi-D), Bluetooth®, Zigbee etc. The wired transceiver 450 may include a transmitter 452 and a receiver 454 configured for wired communication, e.g., with the NG-RAN 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured. e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

One or more of many different techniques may be used to determine position of an entity such as the UE 105. For example, known position-determination techniques include RTT, multi-RTT. RSTD (e.g., OTDOA, also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In RSTD techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In RSTD, the difference in arrival times at a receiving device of signals from different sources along with known locations of the sources and known offset of transmission times from the sources are used to determine the location of the receiving device.

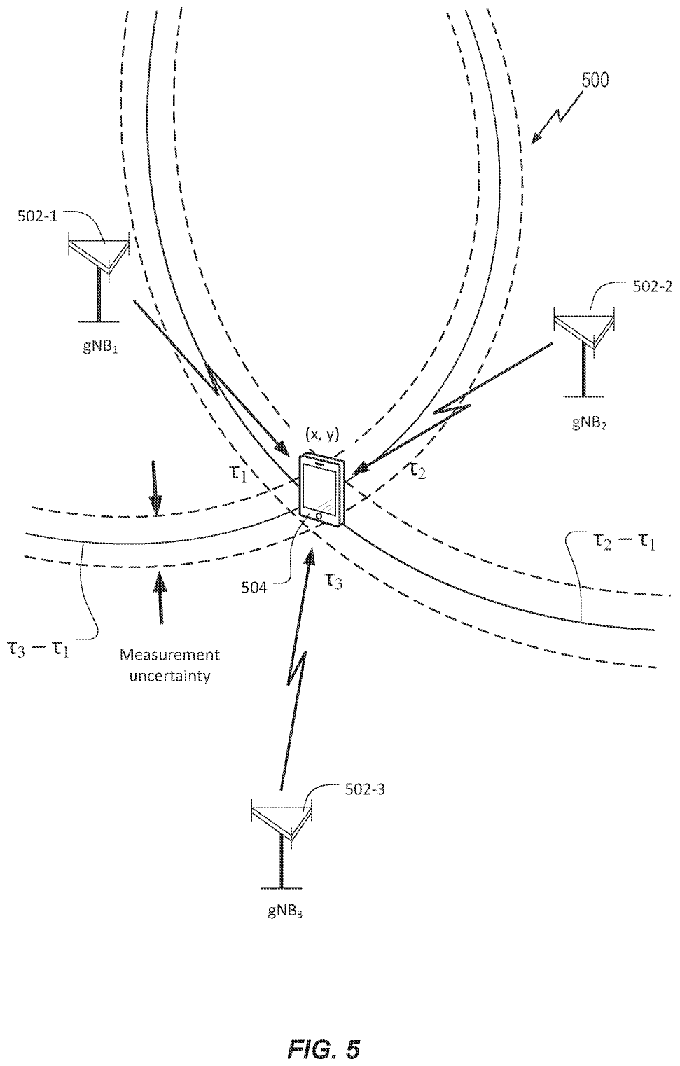

Referring to FIG. 5, an exemplary wireless communications system 500 according to various aspects of the disclosure is shown. In the example of FIG. 5, a UE 504, which may correspond to any of the UEs described herein, is attempting to calculate an estimate of its position, or assist another entity (e.g., a base station or core network component, another UE, a location server, a third party application, etc.) to calculate an estimate of its position. The UE 504 may communicate wirelessly with a plurality of base stations 502-1, 502-2, and 502-3 which may correspond to any combination of the base stations described herein, using RF signals and standardized protocols for the modulation of the RF signals and the exchange of information packets. By extracting different types of information from the exchanged RF signals, and utilizing the layout of the wireless communications system 500 (e.g., the base stations locations, geometry, etc.), the UE 504 may determine its position, or assist in the determination of its position, in a predefined reference coordinate system. In an aspect, the UE 504 may specify its position using a two-dimensional (2D) coordinate system; however, the aspects disclosed herein are not so limited, and may also be applicable to determining positions using a three-dimensional (3D) coordinate system, if the extra dimension is desired. Additionally, while FIG. 5 illustrates one UE 504 and three base stations 502-1, 502-2, 502-3, as will be appreciated, there may be more UEs 504 and more or fewer base stations.

To support position estimates, the base stations 502-1, 502-2, 502-3 may be configured to broadcast positioning reference signals (e.g., PRS, NRS, TRS, CRS, etc.) to UEs in their coverage area to enable a UE 504 to measure characteristics of such reference signals. For example, the observed time difference of arrival (OTDOA) positioning method is a multilateration method in which the UE 504 measures the time difference, known as a reference signal time difference (RSTD), between specific reference signals (e.g., PRS, CRS, CSI-RS, etc.) transmitted by different pairs of network nodes (e.g., base stations, antennas of base stations, etc.) and either reports these time differences to a location server, such as the server 400 (e.g., the LMF 120), or computes a location estimate itself from these time differences.

Generally, RSTDs are measured between a reference network node (e.g., base station 502-1 in the example of FIG. 5) and one or more neighbor network nodes (e.g., base stations 502-2 and 502-3 in the example of FIG. 5). The reference network node remains the same for all RSTDs measured by the UE 504 for any single positioning use of OTDOA and would typically correspond to the serving cell for the UE 504 or another nearby cell with good signal strength at the UE 504. In an aspect, where a measured network node is a cell supported by a base station, the neighbor network nodes would normally be cells supported by base stations different from the base station for the reference cell and may have good or poor signal strength at the UE 504. The location computation can be based on the measured time differences (e.g., RSTDs) and knowledge of the network nodes locations and relative transmission timing (e.g., regarding whether network nodes are accurately synchronized or whether each network node transmits with some known time difference relative to other network nodes).

To assist positioning operations, a location server (e.g., server 400. LMF 120) may provide OTDOA assistance data to the UE 504 for the reference network node (e.g., base station 502-1 in the example of FIG. 5) and the neighbor network nodes (e.g., base stations 502-2 and 502-3 in the example of FIG. 5) relative to the reference network node. For example, the assistance data may provide the center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to OTDOA. The OTDOA assistance data may indicate the serving cell for the UE 504 as the reference network node.

In some cases, OTDOA assistance data may also include “expected RSTD” parameters, which provide the UE 504 with information about the RSTD values the UE 504 is expected to measure at its current location between the reference network node and each neighbor network node, together with an uncertainty of the expected RSTD parameter. The expected RSTD, together with the associated uncertainty, may define a search window for the UE 504 within which the UE 504 is expected to measure the RSTD value. OTDOA assistance information may also include reference signal configuration information parameters, which allow a UE 504 to determine when a reference signal positioning occasion occurs on signals received from various neighbor network nodes relative to reference signal positioning occasions for the reference network node, and to determine the reference signal sequence transmitted from various network nodes in order to measure a signal time of arrival (ToA) or RSTD.

In an aspect, while the location server (e.g., server 400, LMF 120) may send the assistance data to the UE 504, alternatively, the assistance data can originate directly from the network nodes (e.g., base stations 502) themselves (e.g., in periodically broadcasted overhead messages, etc.). Alternatively, the UE 504 can detect neighbor network nodes itself without the use of assistance data.

The UE 504 (e.g., based in part on the assistance data, if provided) can measure and (optionally) report the RSTDs between reference signals received from pairs of network nodes. Using the RSTD measurements, the known absolute or relative transmission timing of each network node, and the known position(s) of the transmitting antennas for the reference and neighboring network nodes, the network (e.g., server 400. LMF 120, a base station 502) or the UE 504 may estimate a position of the UE 504. More particularly, the RSTD for a neighbor network node “k” relative to a reference network node “Ref” may be given as (ToAk-ToARef), where the ToA values may be measured modulo one subframe duration (1 ms) to remove the effects of measuring different subframes at different times. In the example of FIG. 5, the measured time differences between the reference cell of base station 502-1 and the cells of neighboring base stations 502-2 and 502-3 are represented as τ2-τ1 and τ3-τ1, where τ1, τ2, and τ3 represent the ToA of a reference signal from the transmitting antenna(s) of base station 502-1, 502-2, and 502-3, respectively. The UE 504 may then convert the ToA measurements for different network nodes to RSTD measurements and (optionally) send them to the server 400/LMF 120. Using (i) the RSTD measurements. (ii) the known absolute or relative transmission timing of each network node. (iii) the known position(s) of physical transmitting antennas for the reference and neighboring network nodes, and/or (iv) directional reference signal characteristics such as a direction of transmission, the UE's 504 position may be determined (either by the UE 504 or the server 400/LMF 120).

Still referring to FIG. 5, when the UE 504 obtains a location estimate using OTDOA measured time differences, the necessary additional data (e.g., the network nodes' locations and relative transmission timing) may be provided to the UE 504 by a location server (e.g., server 400, LMF 120). In some implementations, a location estimate for the UE 504 may be obtained (e.g., by the UE 504 itself or by the server 400/LMF 120) from OTDOA measured time differences and from other measurements made by the UE 504 (e.g., measurements of signal timing from global positioning system (GPS) or other global navigation satellite system (GNSS) satellites). In these implementations, known as hybrid positioning, the OTDOA measurements may contribute towards obtaining the UE's 504 location estimate but may not wholly determine the location estimate.

Uplink time difference of arrival (UTDOA) is a similar positioning method to OTDOA, but is based on uplink reference signals (e.g., sounding reference signals (SRS), uplink positioning reference signals (UL PRS). SRS for positioning signals) transmitted by the UE (e.g., UE 504). Further, transmission and/or reception beamforming at the base station 502-1, 502-2, 502-3 and/or UE 504 can enable wideband bandwidth at the cell edge for increased precision. Beam refinements may also leverage channel reciprocity procedures in 5G NR.

In NR, there is no requirement for precise timing synchronization across the network. Instead, it is sufficient to have coarse time-synchronization across gNBs (e.g., within a cyclic prefix (CP) duration of the OFDM symbols). Coarse timing synchronization is generally sufficient for Round-trip-time (RTT)-based methods, and the sidelink assisted methods described herein, and as such, are a practical positioning methods in NR.

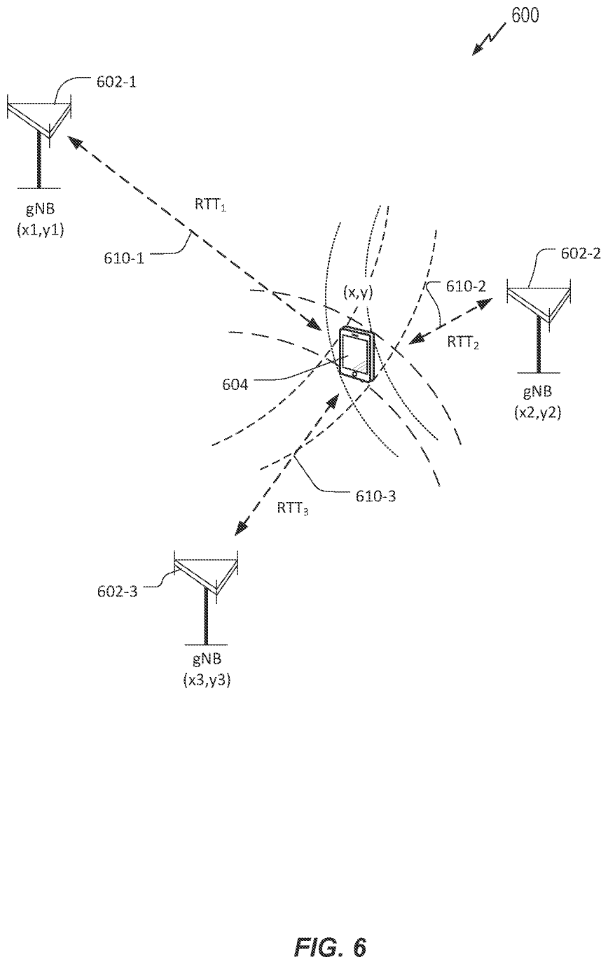

Referring to FIG. 6, an exemplary wireless communications system 600 according to aspects of the disclosure is shown. In the example of FIG. 6, a UE 604 (which may correspond to any of the UEs described herein) is attempting to calculate an estimate of its position, or assist another entity (e.g., a base station or core network component, another UE, a location server, a third party application, etc.) to calculate an estimate of its position. The UE 604 may communicate wirelessly with a plurality of base stations 602-1, 602-2, and 602-3 (which may correspond to any of the base stations described herein) using RF signals and standardized protocols for the modulation of the RF signals and the exchange of information packets. By extracting different types of information from the exchanged RF signals, and utilizing the layout of the wireless communications system 600 (i.e., the base stations locations, geometry, etc.), the UE 604 may determine its position, or assist in the determination of its position, in a predefined reference coordinate system. In an aspect, the UE 604 may specify its position using a two-dimensional coordinate system; however, the aspects disclosed herein are not so limited, and may also be applicable to determining positions using a three-dimensional coordinate system, if the extra dimension is desired. Additionally, while FIG. 6 illustrates one UE 604 and three base stations 602-1, 602-2, 602-3, as will be appreciated, there may be more UEs 604 and more base stations.

To support position estimates, the base stations 602-1, 602-2, 602-3 may be configured to broadcast reference RF signals (e.g., PRS, NRS, CRS, TRS, CSI-RS, PSS. SSS, etc.) to UEs 604 in their coverage area to enable a UE 604 to measure characteristics of such reference RF signals. For example, the UE 604 may measure the ToA of specific reference RF signals (e.g., PRS. NRS. CRS, CSI-RS, etc.) transmitted by at least three different base stations and may use the RTT positioning method to report these ToAs (and additional information) back to the serving base station (e.g., base station 602-2) or another positioning entity (e.g., server 400. LMF 120).

In an aspect, although described as the UE 604 measuring reference RF signals from a base station 602-1, 602-2, 602-3, the UE 604 may measure reference RF signals from one of multiple cells supported by a base station 602-1, 602-2, 602-3. Where the UE 604 measures reference RF signals transmitted by a cell supported by a base station 602-2, the at least two other reference RF signals measured by the UE 604 to perform the RTT procedure would be from cells supported by base stations 602-1, 602-3 different from the first base station 602-2 and may have good or poor signal strength at the UE 604.

In order to determine the position (x, y) of the UE 604, the entity determining the position of the UE 604 needs to know the locations of the base stations 602-1, 602-2, 602-3, which may be represented in a reference coordinate system as (xₖ, yₖ), where k=1, 2, 3 in the example of FIG. 6. Where one of the base stations 602-2 (e.g., the serving base station) or the UE 604 determines the position of the UE 604, the locations of the involved base stations 602-1, 602-3 may be provided to the serving base station 602-2 or the UE 604 by a location server with knowledge of the network geometry (e.g., server 400, LMF 120). Alternatively, the location server may determine the position of the UE 604 using the known network geometry.

Either the UE 604 or the respective base station 602-1, 602-2, 602-3 may determine the distance (dₖ, where k=1, 2, 3) between the UE 604 and the respective base station 602-1, 602-2, 602-3. In an aspect, determining the RTT 610-1, 610-2, 610-3 of signals exchanged between the UE 604 and any base station 602-1, 602-2, 602-3 can be performed and converted to a distance (dₖ). RTT techniques can measure the time between sending a signaling message (e.g., reference RF signals) and receiving a response. These methods may utilize calibration to remove any processing and hardware delays. In some environments, it may be assumed that the processing delays for the UE 604 and the base stations 602-1, 602-2, 602-3 are the same. However, such an assumption may not be true in practice.

Once each distance dx is determined, the UE 604, a base station 602-1, 602-2, 602-3, or the location server (e.g., server 400. LMF 120) can solve for the position (x, y) of the UE 604 by using a variety of known geometric techniques, such as, for example, trilateration. From FIG. 6, it can be seen that the position of the UE 604 ideally lies at the common intersection of three semicircles, each semicircle being defined by radius dx and center (xₖ, yₖ), where k=1, 2, 3.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE 604 from the location of a base station 602-1, 602-2, 602-3). The intersection of the two directions at or near the point (x, y) can provide another estimate of the location for the UE 604.

A position estimate (e.g., for a UE 604) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

UEs may be classified as reduced capability UEs (RedCap UEs), such as bandwidth limited UEs (e.g., wearables, such as smart watches, glasses, rings, etc.). Other UEs may have more capabilities as compared to RedCap UEs and may be referred to as premium UEs (e.g., smartphones, tablet computers, laptop computers, etc.). RedCap UEs generally have lower baseband processing capability, fewer antennas, lower operational bandwidth capabilities, and lower uplink transmission power compared to premium UEs. Different UE tiers can normally be differentiated by UE category or by UE capability. Certain tiers of UEs may also report to the network their type (reduced capability or premium). Alternatively, certain resources/channels may be dedicated to certain types of UEs.

As will be appreciated, the accuracy of positioning a RedCap UEs (e.g., NR-Light UEs) may be limited. For example, a RedCap UE may operate on a reduced bandwidth, such as 5 to 20 MHz for wearables and relaxed IoT (i.e., IoT devices with relaxed parameters, such as lower throughput, relaxed delay requirements, lower energy consumption, etc.), which results in lower positioning accuracy. As another example, a RedCap UE's receiver processing capability may be limited due to its lower cost RF/baseband. As such, the reliability of measurements and positioning computations would be reduced. In addition, such a RedCap UE may not be able to receive multiple PRS from multiple TRPs, further reducing positioning accuracy. As yet another example, the transmit power of a RedCap UE may be reduced, meaning there would be a lower quality of uplink measurement for RedCap UE positioning.

However, RedCap UEs, such as wearables, are often operated around premium UEs. As such, the present disclosure provides techniques for a RedCap UE to leverage sidelink communications with one or more premium UEs to improve RSTD and other positioning measurements.

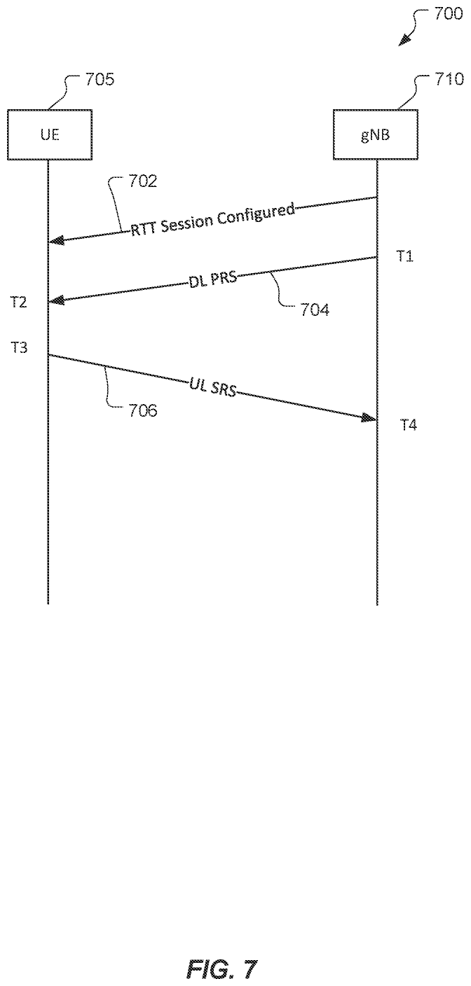

Referring to FIG. 7, an example round trip message flow 700 between two wireless nodes such as a user equipment 705 and a base station 710 is shown. The UE 705 is an example of the UE 105, 200 and the base station 710 may be a gNB 110a-b or ng-eNB 114. In general, RTT positioning methods utilize a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. The example message flow 700 may be initiated by the base station 710 with a RTT session configure message 702. The base station may utilize the LPP/NRPPa messaging to configure the RTT session. At time T1, the base station 710 may transmit a DL PRS 704, which is received by the UE 705 at time T2. In response, the UE 705 may transmit a Sounding Reference Signal (SRS) for positioning message (e.g., UL-SRS) 706 at time T3 which is received by the base station 710 at time T4. The distance between the UE 705 and the base station 710 may be computed as:

$$distance = \frac{c}{2} ( ( T 4 - T 1 ) - ( T 3 - T 2 ) ) \qquad ( 1 )$$

where c=speed of light.

In operation, the UE 705 may be a RedCap UE capable of receiving the DL PRS 704 but without sufficient transmit power to enable the serving base station (e.g., the base station 710) to receive the UL SRS 706. The sidelink aided downlink positioning methods described herein may be used to overcome this limitation. In another example, a RedCap UE may have sufficient uplink power to provide the UL SRS 706 to is serving station, but insufficient power for more distant stations to receive the SRS. The sidelink aided uplink positioning methods described herein may be used to overcome this limitation.

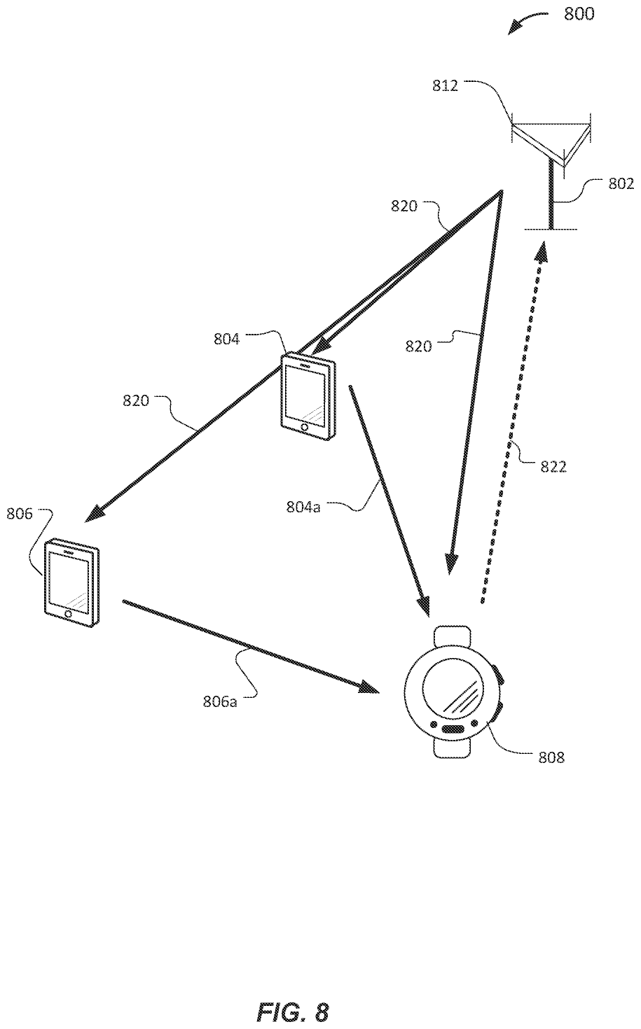

Referring to FIG. 8, a block diagram 800 of an example sidelink aided downlink time difference of arrival based positioning method is shown. The diagram 800 depicts a plurality of wireless nodes in a communication system 100 such as a base station 802 (e.g., a TRP 300 such as a gNB or any of the base stations described herein), a first UE 804, a second UE 806, and a RedCap UE 808 (also referred to as NR-light UE). The base station 802 has multiple antennas, such as a panel of antennas 812 (e.g., the antenna arrays on a particular side of the base station 802) may correspond to a cell and/or TRP supported by the base station 802. In the example of FIG. 8, the first UE 804 and the second UE 806 are illustrated as smartphones (e.g., premium UEs) and the RedCap UE 808 is illustrated as a smartwatch. These, however, are examples and do not limit the disclosure.

As further illustrated in FIG. 8, the first UE 804, the second UE 806, and the RedCap UE 808 receive a DL PRS 820 transmitted from the base station 802. The RedCap UE 808 is configured to receive sidelink communications from the UEs 804, 806 over respective sidelinks such as a first sidelink signal 804a, and a second sidelink signal 806a. The wireless sidelink signals 804a, 806a may be an NR sidelink, and may support a physical sidelink control channel (PSCCH), a physical sidelink shared channel (PSSCH), a physical sidelink broadcast channel (PSBCH), or other sidelink shared channel (SL-SCH) between the UEs 804, 806 and the RedCap UE 808. A sidelink channel state information reference signal (CSI-RS) may be configured within the PSSCH transmission. In an example, the RedCap UE 808 may be configured to provide UL signals 822 to the base station 802.

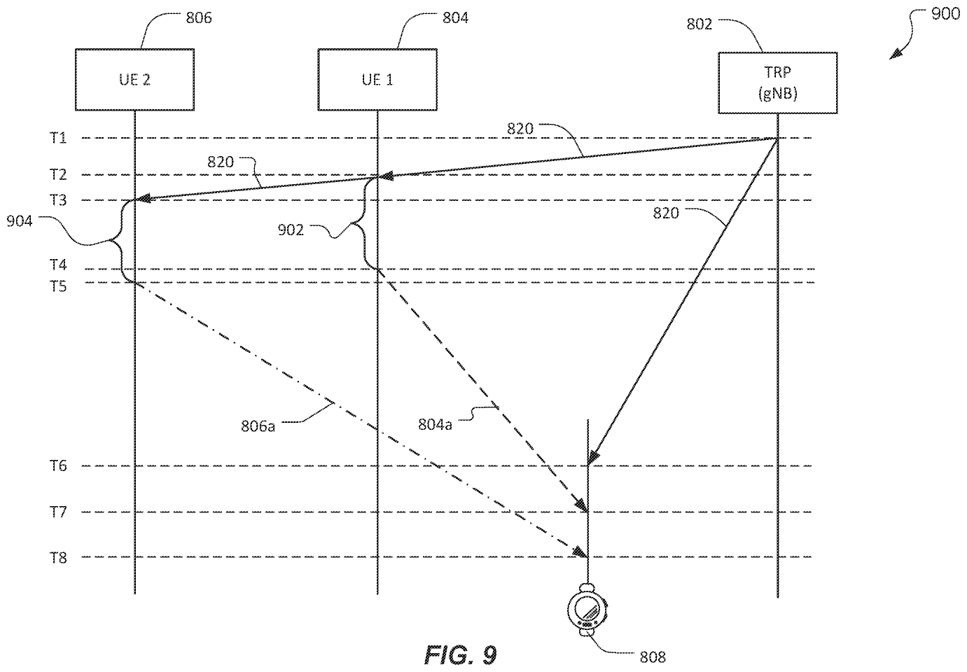

In operation, the RedCap UE 808 may utilize the sidelink signals transmitted by one or more of the UEs 804, 806 to obtain a sidelink aided downlink (DL) RSTD measurement. For example, referring to FIG. 9, a message timing diagram 900 for an example sidelink aided DL-TDOA positioning method is shown. In an example, the base station 802 may be the serving cell for the RedCap UE 808 and configured to transmit the DL PRS 820, or other reference signals at time T1. The first and second UEs 804, 806 may receive the DL PRS 820 at times T2 and T3 as depicted in the diagram 900. Since the sidelink aided positioning methods described herein are not dependent on a time synchronization between stations, the first and second UEs 804, 806 may be camped on the base station 802, or on other cells. The RedCap UE 808 also receives the DL PRS 820 at time T6 (the timing labels T1-T8 in the diagram 900 do not necessarily indicate a chronological order). The first UE 804 is configured to transmit a first sidelink signal 804a to the RedCap UE 808 at time T4, which may be based on a defined first Rx-Tx delay value 902 (i.e., T4-T2). The second UE 806 is configured to transmit a second sidelink signal 806a to the RedCap UE 808 at time T5, which may be based on a defined second Rx-Tx delay value 904 (i.e., T5-T3). The RedCap UE 808 receives the first and second sidelink signals at times T7 and T8 respectively, and is configured to determine time of arrival of the DL PRS 820, and the first and second sidelink signals 804a, 806a. The first and second UEs 804, 806 may report their respective Rx-Tx delay values 902, 904 to the RedCap UE 808, the base station 802, or other network entity (e.g., LMF 120 or other network server).

In an embodiment, the range between the base station 802 and the first and second UEs 804, 806 may be known. For example, via OTDOA, RSTD, RTT or other NR based or RAT independent positioning methods (e.g., high precision PRS or other hybrid positioning methods). In an example, the first and second UEs 804, 806 may obtain a location based on a satellite navigation system such as the SPS receiver 217. Thus, the respective propagation times T2-T1 and T3-T1 are known. The RedCap UE 808, or other network entity, may be configured to determine the RSTD between the signals transmitted by the base station 802 (e.g., DL PRS 820) and the first UE 804 (e.g., the first sidelink signal 804a) as:

$${RSTD}_{UE 1} = {ToA}_{BS} - {ToA}_{UE 1} \qquad ( 2 )$$

$${RSTD}_{UE 1} = ( T 6 - T 7 ) - ( ( T 2 - T 1 ) + ( T 4 - T 2 ) ) \qquad ( 3 )$$

where,
T6 is the Rx time of the DL PRS transmitted by the base station;
T7 is the Rx time of the sidelink signal transmitted by UE 1;
T2-T1 is the estimated propagation time between the base station and UE 1; and
T4-T2 is the reported Rx-Tx delay time for UE 1.

The RSTD between signals transmitted by the base station 802 and the second UE 806 may follow the same approach based on the second sidelink signal, such that:

$${RSTD}_{UE 2} = {ToA}_{BS} - {ToA}_{UE 2} \qquad ( 4 )$$

$${RSTD}_{UE 2} = ( T 6 - T 8 ) - ( ( T 3 - T 1 ) + ( T 5 - T 3 ) ) \qquad ( 5 )$$

where,
T6 is the Rx time of the DL PRS transmitted by the base station;
T8 is the Rx time of the sidelink signal transmitted by UE 2;
T3-T1 is the estimated propagation time between the base station and UE 2; and
T5-T3 is the reported Rx-Tx delay time for UE 2.

In an UE based positioning use case, the first and second UEs 804, 806 may report the respective propagation times (e.g., T2-T1, T3-T1) and Rx-Tx delay times (e.g., T4-T2, T5-T3) to the RedCap UE 808 via a sidelink channel such as the PSSCH, PSCCH or other sidelink channels. In a UE assisted positioning use case, the first and second UEs 804, 806 may report the respective propagation times (e.g., T2-T1, T3-T1) to a network entity (e.g., LMF 120) via LPP, RRC, or other messaging format, and report the Rx-Tx delay times (e.g., T4-T2, T5-T3) to the RedCap UE 808 via a sidelink channel such as the PSSCH, PSCCH or other sidelink channels. In another example, the first and second UEs 804, 806 may report the Rx-Tx delay times (e.g., T4-T2, T5-T3) to the network server (e.g., LMF 120), and the network server may provide the propagation times (e.g., T2-T1, T3-T1) and Rx-Tx delay times (e.g., T4-T2, T5-T3) to the RedCap UE 808 via network signaling such as LPP. RRC, SIBs, DCI, etc.

While the diagram 900 includes one base station and three UEs, the depicted RSTD method and corresponding equations may be used with combinations of multiple base stations and multiple UEs. The sidelink aided DL positioning method of the diagram 900 does not depend on timing synchronization between the wireless nodes, and the first and second UEs 804, 806 and the RedCap UE 808 may be associated with different serving cells. Further, the independence from a synchronized time may increase the accuracy of DL-RSTD positioning.

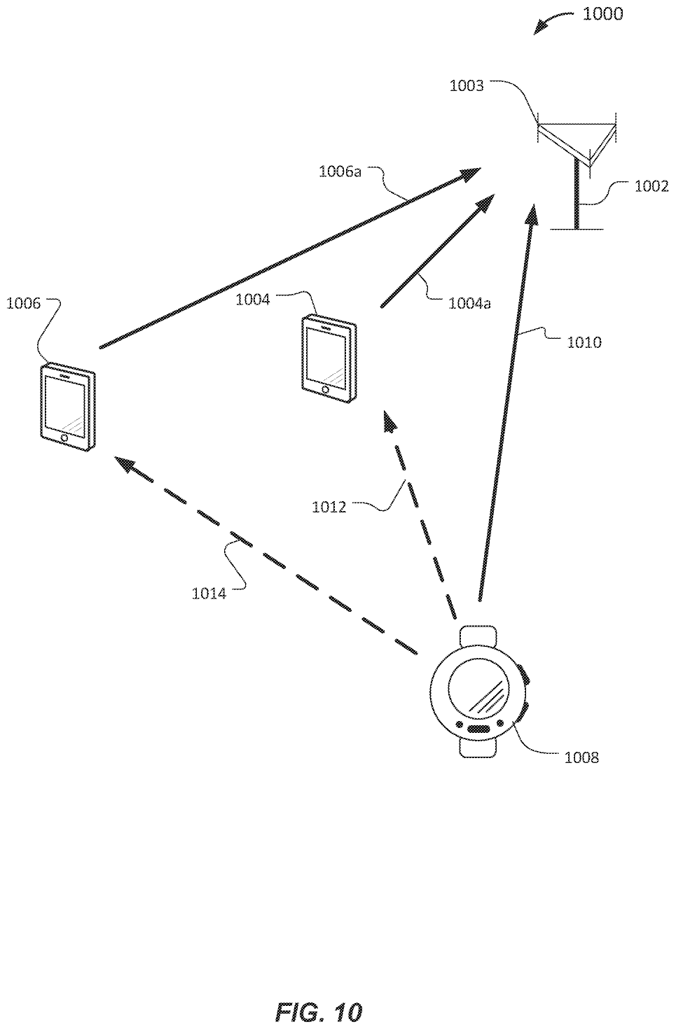

Referring to FIG. 10, a block diagram 1000 of an example sidelink aided uplink time difference of arrival based positioning method is shown. The diagram 1000 depicts a plurality of wireless nodes in a communication system 100 such as a base station 1002 (e.g., a TRP 300 such as a gNB or any of the base stations described herein), a first UE 1004, a second UE 1006, and a RedCap UE 1008. The base station 1002 has multiple antennas, such as a panel of antennas 1003 (e.g., the antenna arrays on a particular side of the base station 1002) may correspond to a cell and/or TRP supported by the base station 1002. In the example of FIG. 10, the first UE 1004 and the second UE 1006 are illustrated as smartphones (e.g., premium UEs) and the RedCap UE 1008 is illustrated as a smartwatch. These, however, are examples and do not limit the disclosure.

As further illustrated in FIG. 10, the first UE 1004, the second UE 1006, and the RedCap UE 1008 are configured to transmit uplink signals, such as UL-SRS signals which may be received by one or more base stations. For example, the RedCap UE 1008 may be configured to transmit a UL SRS 1010, the first UE 1004 may be configured to transmit an UL-SRS, and the second UE 1006 may be configured to transmit a UL SRS 1006a, which may be received by the base station 1002. The RedCap UE 1008 is configured to transmit sidelink communications to the first and second UEs 1004, 1006 via one or more sidelink signals such as a first sidelink signal 1012, and a second sidelink signal 1014. The sidelink signals 1012, 1014 may utilize NR sidelink protocols and channels such as the PSCCH, the PSSCH, the PSBCH, or other sidelink shared channels (SL-SCH) between the UEs 1004, 1006 and the RedCap UE 1008. A sidelink CSI-RS may be configured within the PSSCH transmission.

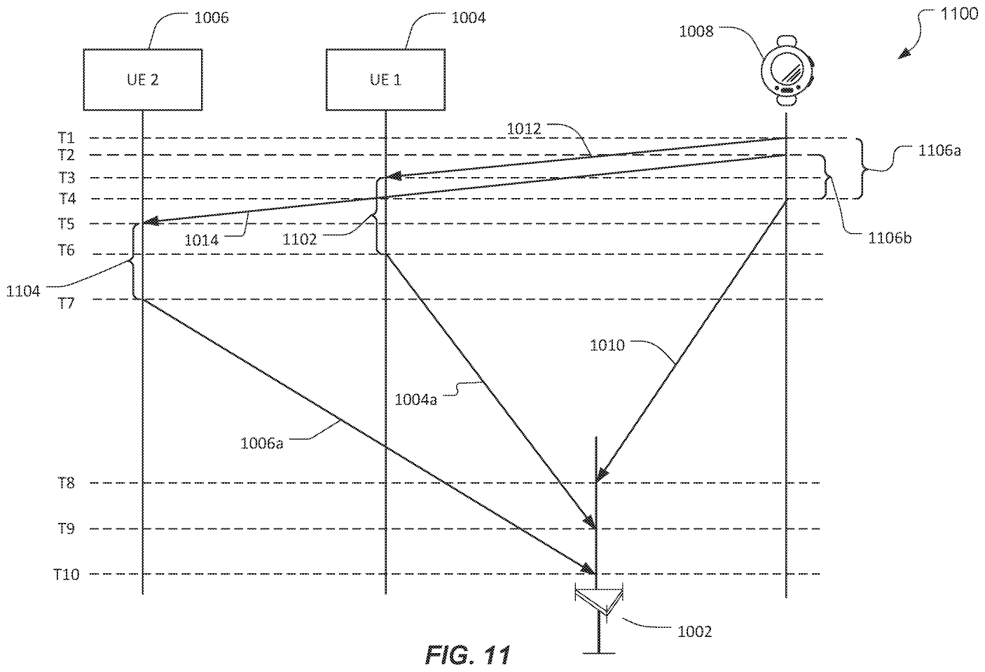

In operation, the RedCap UE 1008 may transmit sidelink signals to one or more of the UEs 1004, 1006 to provide a sidelink aided uplink (UL) RSTD measurement. For example, referring to FIG. 11, a message timing diagram 1100 for an example sidelink aided UL-TDOA positioning method is shown. In an example, the RedCap UE 1008 is configured to transmit UL SRS and sidelink signals. For example, the RedCap UE 1008 may transmit the first sidelink signal 1012 to the first UE 1004 at time T1 and the second sidelink signal 1014 to the second UE 1006 at time T2. The RedCap UE 1008 may also transmit an UL SRS 1010 at time T4 (the timing labels T1-T10 in the diagram 1100 do not necessarily indicate a chronological order). The RedCap UE 1008 may be configured to determine and report the time differences between the sidelink and UL SRS transmission times, such as a first delta SRS-sidelink delay 1106a (e.g., T4-T1), and a second SRS-sidelink delay 1106b (e.g., T4-T2) to the base station 1002, or other network entity such as the LMF 120. The first UE 1004 may receive the first sidelink signal 1012 at time T3 and transmit the UL SRS 1004a at time T6, which may be based on a defined first Rx-Tx delay value 1102. The second UE 1006 may receive the second sidelink signal 1014 at time T5 and transmit the UL SRS 1006a at time T7, which may be based on a defined second Rx-Tx delay value 1104. The first and second UEs 1004, 1006 may report the respective Rx-Tx delay time values 1102, 1104 to the base station 1002 or other network entity (e.g., LMF 120). The base station 1002 may receive the UL SRS 1010, 1004a. 1006a at times T8, T9 and T10, respectively and may be configured to determine RSTD values and report them to a network entity, such as the LMF 120.

In an embodiment, the range between the base station 1002 and the first and second UEs 1004, 1006 may be known. For example, via OTDOA. RSTD, RTT or other NR based or RAT independent positioning methods (e.g., high precision PRS or other hybrid positioning methods) In an example, the first and second UEs 1004, 1006 may obtain a location based on a satellite navigation system such as the SPS receiver 217. Thus, the respective UL SRS propagation times T10-T7 and T9-T6 are known. The base station 1002, or other network entity, may be configured to determine the RSTD between the signals transmitted by the RedCap UE 1008 (e.g., UL SRS 1010) and the UL SRS 1004a received from first UE 1004, which is based at least in part on the first sidelink signal 1012. In an example, the RSTD associated with the first UE 1004 is computed as:

$${RSTD}_{UE 1} = {ToA}_{BS} - {ToA}_{UE 1} \qquad ( 6 )$$

$${RSTD}_{UE 1} = ( T 8 - T 9 - [ delta SRS - sidelink ] ) - ( ( T 9 - T 6 ) + ( T 6 - T 3 ) ) \qquad ( 7 )$$

where,
T8 is the Rx time of the UL PRS transmitted by RedCap UE;
T9 is the Rx time of the UL PRS transmitted by UE 1;
[delta SRS-sidelink] is the first delta SRS-sidelink delay 1106a indicating a time delay between transmitting the first sidelink and the UL PRS (i.e., T4-T1);
T9-T6 is the estimated propagation time between the base station and UE 1; and
T6-T3 is the reported Rx-Tx delay value 1102 time for UE 1.

The RSTD between signals transmitted to the base station 1002 from the RedCap UE 1008 and the second UE 1006 may follow the same approach based on the second sidelink signal 1014, such that:

$${RSTD}_{UE 2} = {ToA}_{BS} - {ToA}_{UE 2} \qquad ( 8 )$$

$${RSTD}_{UE 2} = ( T 8 - T 10 - [ delta SRS - sidelink ] ) - ( ( T 10 - T 7 ) + ( T 7 - T 5 ) ) \qquad ( 9 )$$

where,
T8 is the Rx time of the UL PRS transmitted by RedCap UE;
T10 is the Rx time of the UL PRS transmitted by UE 2;
[delta SRS-sidelink] is the second SRS-sidelink delay 1106b indicating a time delay between transmitting the second sidelink and the UL PRS (i.e., T4-T2);
T10-T7 is the estimated propagation time between the base station and UE 2; and
T7-T5 is the reported Rx-Tx delay time value 1104 for UE 2.

The base station 1002 needs to measure the receive times for the UL SRS 1010, 1004a, 1006a, which can be achieved without a tight synchronization requirement across the UEs. The first and second UEs 1004, 1006, and/or the base station 1002 may be configured to report the respective signal propagation times and Rx-Tx delay time values 1102, 1104 to a positioning entity such as the LMF 120. The signal propagation times (e.g., T9-T6, T10-T7) may be estimated via NR positioning methods, and/or other RAT independent methods. In an example, the RedCap UE 1008 may report the delta SRS-sidelink values 1106a-b to a positioning server via the base station 1002. In an example, the delta SRS-sidelink values 1106a-b may be based on a grant from a serving gNB (e.g., the base station 1002), which may report the delta SRS-sidelink values 1106a-b to the positioning entity and/or to the first and second UEs 1004, 1006 and eliminate the requirement for the RedCap UE 1008 to report the values.

While the diagram 1100 includes one base station and three UEs, the depicted TDOA method and corresponding equations may be used with combinations of multiple base stations and multiple UEs. The sidelink aided UL positioning method of the diagram 1100 does not depend on timing synchronization between the wireless nodes, and the first and second UEs 1004, 1006 and the RedCap UE 1008 may be associated with different serving cells. Further, the independence from a synchronized time may increase the accuracy of UL-TDOA positioning.

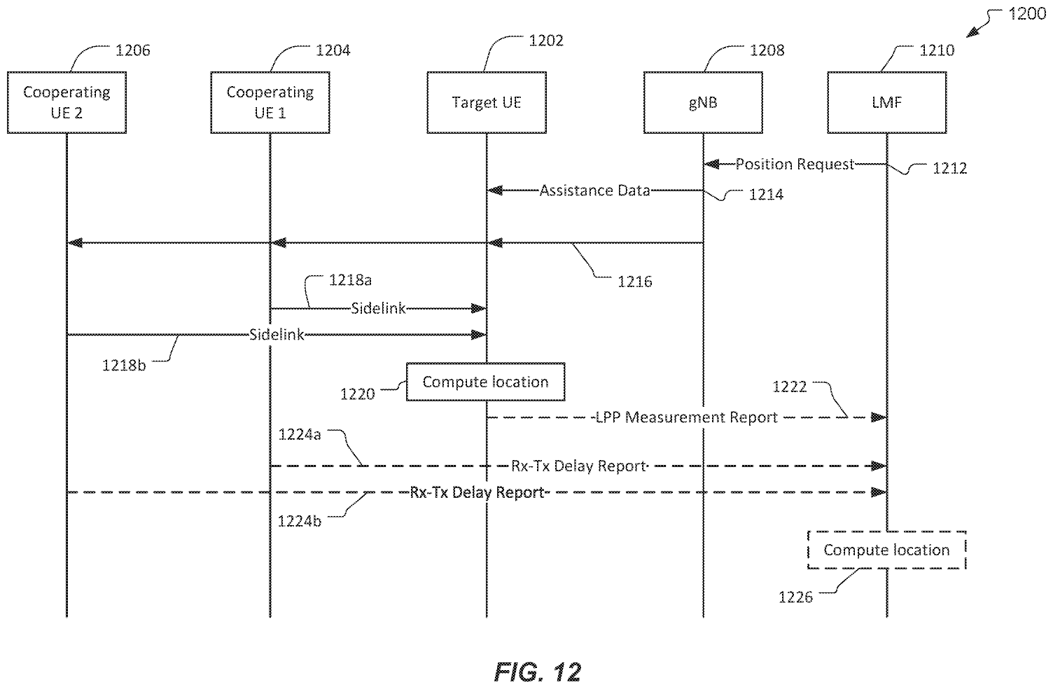

Referring to FIG. 12, an example message flow diagram 1200 of a sidelink aided DL TDOA based positioning method is shown. The message flow may be utilized in a communication system 100, including a target UE 1202, a first cooperating UE 1204, a second cooperating UE 1206, a gNB 1208 and an LMF 1210. The target UE 1202 and the cooperating UEs 1204, 1206 may include some or all of the features of the UE 200, and the UE 200 is an example of the target UE 1202 and the cooperating UEs 1204, 1206. In an example, the target UE 1202 may be a reduced capability UE. The gNB 1208 may include some or all of the features of the TRP 300, and the TRP 300 is an example of the gNB 1208. The LMF 1210 may include some or all of the features of the server 400, and the server 400 is an example of the LMF 1210. The message flow 1200 may utilize one or more network protocols such as LPP/NRPP. RRC, DCI, and MAC-CE messaging to transfer positioning information such as ToA values, estimated propagation times, Rx-Tx delay values, delta SRS-sidelink values, and other channel and station related assistance data.

In an embodiment, the LMF 1210 may be configured to obtain position information for one or more stations in a network, such as the target UE 1202. The LMF 1210 may send a position request message 1212 to a serving station such as the gNB 1208 to initiate a positioning procedure for the target UE 1202. The position request message 1212, or other messages from the LMF 1210, may include OTDOA assistance data to enable the gNB 1208 or the target UE 1202 to compute a location. In an embodiment, the target UE 1202 may initiate a positioning procedure. The gNB 1208 may send one or more assistance data messages 1214 including positioning information to assist the target UE 1202, and other stations, to obtain reference signal measurements and determine a location. For example, the assistance data messages may include PRS and SRS resource information, neighbor lists indicating proximate wireless nodes including other base stations and cooperating UEs, sidelink configuration information. Rx-Tx delay information, station location, muting pattern information, and other data relevant to OTDOA or other terrestrial positioning methods as known in the art. The gNB 1208, and other stations in the network, may be configured to transmit one or more reference signals for positioning such as DL PRS 1216 which may be received by the target UE 1202 and one or more neighboring stations such as the cooperating UEs 1204, 1206. In an example, upon receipt of the DL PRS 1216, the cooperating UEs 1204, 1206 may transmit one or more sidelink signals 1218a-b to the target UE 1202 via one or more sidelink channels (e.g., PSSCH, PSCCH, etc.). The timing of the transmission of the sidelink signals 1218a-b may be based on respective Rx-Tx delay values 902, 904 as described in FIG. 9. In an embodiment, the cooperating UEs 1204, 1206 may be configured to report the respective Rx-Tx delay values, and estimated propagation delay (e.g., based on the ranges to the gNB 1208) to the target UE 1202 via the sidelink signals 1218a-b. At stage 1220, the target UE 1202 may determine RSTD values based on received assistance data, and the ToAs of the DL PRS 1216 and the sidelink signals 1218a-b. In an embodiment, the target UE 1202 may be configured to utilize the RSTD values and assistance data received from the gNB 1208 and/or the cooperating UEs 1204, 1206 to determine the RSTD values (e.g., equations (2) and (3)) and compute a location. In an example, the location may be based on the multilateration techniques discussed in FIG. 5.

The target UE 1202 may be configured to report ToA. RSTD, and other measurement values to a network entity such as the LMF 1210 via one or more LPP measurement report messages 1222. For example, the report messages 1222 may include the ToA, RSTD, and/or other measurement values based on the DL PRS 1216 and sidelink signals 1218a-b received by the target UE 1202. In an embodiment, the cooperating UEs 1204, 1206 may be configured to send Rx-Tx delay report messages 1224a-b to report the respective Rx-Tx delay values associated with receiving the DL PRS 1216 and transmitting the sidelink signals 1218a-b. The Rx-Tx delay report messages 1224a-b may also include the estimated propagation delay values (e.g., T2-T1, T3-T1) based on the range between the gNB 1208 and the cooperating UEs 1204, 1206. In an embodiment, the LMF 1210, or other network resource, may determine the estimated propagation delay values to reduce the reporting requirements of the cooperating UEs 1204, 1206. At stage 1226, the LMF 1210 may be configured to compute the RSTD values (e.g., equations (2) and (3)) and determine the location of the target UE 1202 using multilateration techniques such as described in FIG. 5 based on RSTD measurements reported by the target UE 1202 and the Rx-Tx delay report messages 1224a-b. The message flow 1200 is an example, and not a limitation as other messages and messaging techniques may be used to implement a sidelink aided DL PRS positioning method.

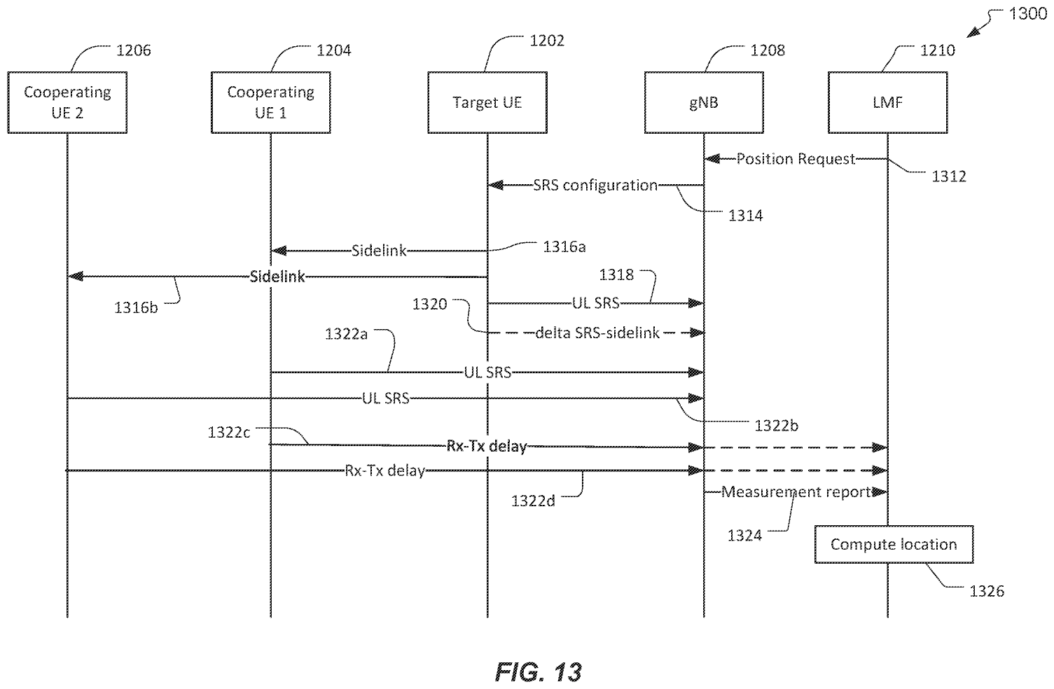

Referring to FIG. 13, an example message flow 1300 of a sidelink aided UL TDOA based positioning method is shown. The message flow may be utilized in a communication system 100, including the target UE 1202, the first cooperating UE 1204, the second cooperating UE 1206, the gNB 1208 and the LMF 1210 as described in FIG. 12. The message flow 1300 may utilize one or more network protocols such as LPP/NRPP. RRC, DCI, and MAC-CE messaging to active a UL SRS process and to transfer positioning information such as ToA values, estimated propagation times, Rx-Tx delay values, delta SRS-sidelink values, and other channel and station related assistance data.

In an embodiment, the LMF 1210 may be configured to obtain position information for one or more stations in a network, such as the target UE 1202. The LMF 1210 may send a position request message 1312 to one or more base stations such as the gNB 1208 configured to obtain the position of the target UE 1202. The position request message 1312 may also include assistance data such as the identification of neighboring UEs (e.g., the cooperating UEs), OTDOA assistance data, and estimated propagation values (e.g., based on the ranges between the gNB and the UEs). The gNB 1208 may configure SRS resources for the target UE 1202 and provide the SRS resource information and other assistance data via one or more SRS configuration messages 1314. In an embodiment, the SRS configuration information may include sidelink grant information indicating the delts SRS-sidelink values for the target UE 1202 to use with neighboring UEs. The target UE 1202 may be configured to transmit one or more sidelink signals 1316a-b via one or more sidelink channels to the cooperating UEs 1204, 1206. The target UE 1202 may transmit one or more UL SRS 1318, which may be received by the gNB 1208 or other stations. The target UE 1202 may also send one or more delta SRS-sidelink reporting messages 1320 to provide the gNB 1208, and/or the LMF 1210 the delta SRS-sidelink values 1106a-b associated with the sidelink signals 1316a-b and the UL SRS 1318.

The cooperating UEs 1204, 1206 are configured to transmit one or more UL SRS 1322a-b, which are received by the gNB 1208. The cooperating UEs 1204, 1206 may also report the respective Rx-Tx delay values 1102, 1104 in one or more Rx-Tx delay messages 1322c-d to the gNB 1208 or the LMF 1210. The gNB 1208 is configured to determine the ToA, RSTD, and other measurements based on the received UL SRS 1318, 1322a-b as described in equations (6) and (7). The gNB 1208 may provide one or more measurement reports 1324 including the RSTD values to the LMF 1210, and at stage 1326 the LMF 1210 may utilize multilateration methods to determine the location of the target UE 1202. In an embodiment, the gNB 1208 may be configured to determine the location of the target UE 1202. The message flow 1300 is an example, and not a limitation as other messages and messaging techniques may be used to implement a sidelink aided UL PRS positioning method.

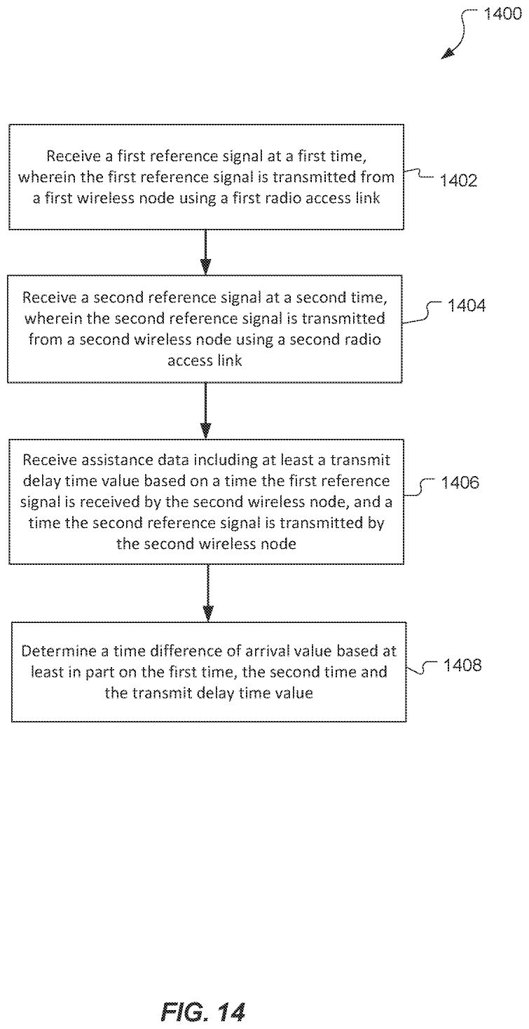

Referring to FIG. 14, with further reference to FIGS. 1-13, a method 1400 of determining a time difference of arrival in sidelink aided downlink positioning includes the stages shown. The method 1400 is, however, an example and not limiting. The method 1400 may be altered. e.g., by having stages added, removed, rearranged, combined, performed concurrently, and/or having single stages split into multiple stages.

At stage 1402, the method includes receiving a first reference signal at a first time, wherein the first reference signal is transmitted from a first wireless node using a first radio access link. The UE 200, including the transceiver 215 and the general-purpose processor 230 are a means for receiving the first reference signal. In an embodiment, the first reference signal may be a DL PRS 1216 transmitted by the gNB 1208 and received by the target UE 1202. The first radio access link may utilize a cellular wide area network (WAN) technology such as LTE, 5G NR or other RATs as described in FIG. 1. Other reference signals (e.g., NRS, TRS, CRS, etc.) may be transmitted from other wireless nodes and received by a UE. The first time may be the time of arrival of the first reference signal at the target UE.

At stage 1404, the method includes receiving a second reference signal at a second time, wherein the second reference signal is transmitted from a second wireless node using a second radio access link. The UE 200, including the transceiver 215 and the general-purpose processor 230 are a means for receiving the second reference signal. In an embodiment, the second reference signal may be a sidelink signal 1218a transmitted from a neighboring wireless node such as the cooperating UE 1204. The second radio access link may be based on a sidelink protocol and utilize a sidelink channel (e.g., PSCCH, PSSCH, or other sidelink channel). In an example, the second reference signal may be a CSI-RS configured within the PSSCH transmission.

At stage 1406, the method includes receiving assistance data including at least a transmit delay time value based on a time the first reference signal is received by the second wireless node, and a time the second reference signal is transmitted by the second wireless node. The UE 200, including the transceiver 215 and the general-purpose processor 230 are a means for receiving the assistance data. In an embodiment, a wireless node on a network may be configured to provide assistance data to a target UE. For example, the gNB 1208 may be configured to provide one or more assistance data messages 1214 including the Rx-Tx delay times and estimated propagation delays associated with a cooperating UE. The assistance data messages 1214 may be based on LPP signaling from the LMF 1210, or RRC signaling including one or more System Information Blocks (SIBs) containing the assistance data. In an example, the cooperating UEs may include assistance data (e.g., Rx-Tx delay times) in one or more sidelink signals 1218a-b. In an example, referring to FIG. 9, the RedCap UE 808 may be the first wireless node, and the first UE 804 may be the second wireless node. The transmit delay time value may be the Rx-Tx delay value 902 based on the time delay between the time T2 when the first UE 804 receives the DL PRS 820, and the time T4 when the first UE 804 transmits the first sidelink signal 804a. The Rx-Tx delay values for other neighboring stations may also be included in the assistance data.

At stage 1408, the method includes determining a time difference of arrival value based at least in part on the first time, the second time and the transmit delay time value. The UE 200, including the general-purpose processor 230, is a means for determining the time difference of arrival. In an embodiment, the RSTD may be computed based on equations (2) and (3). For example, the first reference signal received at the first time at stage 1402 may be the receive time of the DL PRS (e.g., T6), and the second reference signal received at the second time at stage 1404 may be the receive time of the sidelink signal transmitted by the second wireless node (e.g., T7). The reported Rx-Tx delay time for the second wireless node may be included in the assistance data received at stage 1406 (e.g., T4-T2). In an embodiment, the estimated propagation time between the first wireless node and the second wireless node may be included in the assistance data received at stage 1406. The estimated propagation time may be included in other assistance data, or may persist in the memory 211 as almanac data. The method 1400 provides the technical advantage of obtaining RSTD values without the need for a synchronized time between the wireless nodes. In an example, the first wireless node may be a serving cell and the second wireless node may be camped on a different serving cell. The resulting RSTD valued may be used in mutlilateration positioning methods such as described in FIG. 5. Other positioning methods may also be used.

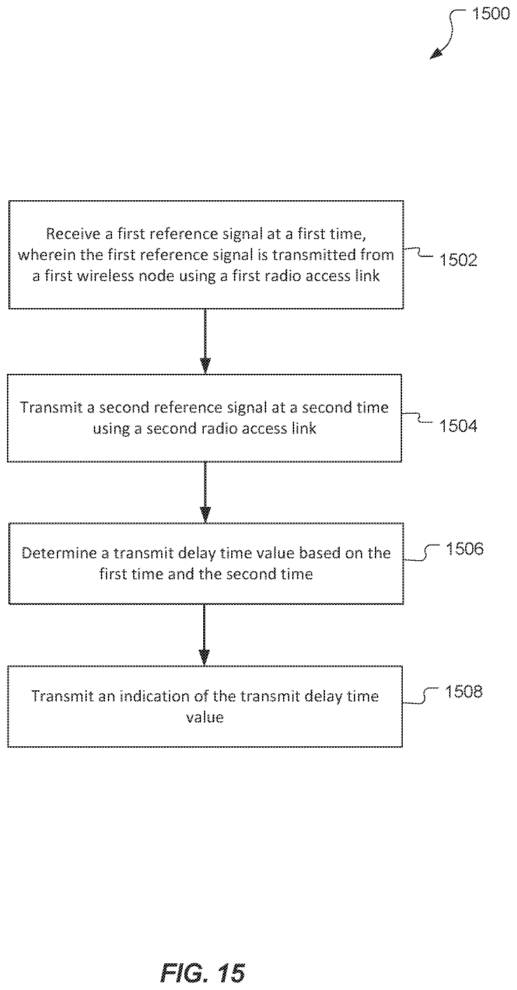

Referring to FIG. 15, with further reference to FIGS. 1-13, a method 1500 of providing sidelink assistance data includes the stages shown. The method 1500 is, however, an example and not limiting. The method 1500 may be altered, e.g., by having stages added, removed, rearranged, combined, performed concurrently, and/or having single stages split into multiple stages. The method 1500 may be utilized with both sidelink aided DL PRS and sidelink aided UL SRS positioning procedures.

At stage 1502, the method includes receiving a first reference signal at a first time, wherein the first reference signal is transmitted from a first wireless node using a first radio access link. The UE 200, including the transceiver 215 and the general-purpose processor 230 are a means for receiving the first reference signal. In a sidelink aided DL PRS embodiment, the first reference signal may be a DL PRS 1216 transmitted by the gNB 1208 and received by a cooperating UE 1204, 1206. The first radio access link may utilize a WAN technology such as LTE, 5G NR or other RATs as described in FIG. 1. Other reference signals (e.g., NRS, TRS, CRS, etc.) may be transmitted from other wireless nodes and received by a UE. The first time may be the time of arrival of the first reference signal at the target UE. In a sidelink aided UL PRS embodiment, the first reference signal may be a sidelink signal 1316a-b transmitted by the target UE 1202. The first radio access link may be based on a sidelink protocol and utilize a sidelink channel (e.g., PSCCH, PSSCH, or other sidelink channel).

At stage 1504, the method includes transmitting a second reference signal at a second time using a second radio access link. The UE 200, including the transceiver 215 and the general-purpose processor 230 are a means for transmitting the second reference signal. In a sidelink aided DL PRS embodiment, the second reference signal may be a sidelink signal 1218a-b transmitted from a cooperating UE 1204, 1206 and received by the target UE 1202. The second radio access link may be based on a sidelink protocol and utilize a sidelink channel (e.g., PSCCH, PSSCH, or other sidelink channel). In an example, the second reference signal may be a CSI-RS configured within the PSSCH transmission. The second time may be based on a pre-configured Rx-Tx delay, or a sidelink grant received from a serving cell. A UE may be configured to transmit the second reference signal at the second time independent of network timing requirements. For example, referring to FIG. 8, the second time may be T4 when the first time is T2. In a sidelink aided UL PRS embodiment, the second reference signal may be an UL SRS 1322a-b transmitted from a cooperating UE 1204, 1206 to the gNB 1208.

At stage 1506, the method includes determining a transmit delay time value based on the first time and the second time. The UE 200, including the general-purpose processor 230 are a means for determining the transmit delay time. The transmit delay time is the Rx-Tx delay between receiving the first reference signal and transmitting the second reference signal. For example, referring to FIG. 9, in a sidelink aided DL PRS method the transmit delay time may be the Rx-Tx delay values 902, 904. In a sidelink aided UL PRS method, the transmit delay time may be Rx-Tx delay values 1102, 1104 depicted in FIG. 11.

At stage 1508, the method includes transmitting an indication of the transmit delay time value. The UE 200, including the transceiver 215 and the general-purpose processor 230 are a means for transmitting the indication of the transmit delay time. In an embodiment, a cooperating UE 1204, 1206 may be configured to provide one or more Rx-Tx delay messages determine at stage 1506 to a network entity such as the LMF 1210 and/or the gNB 1208. For example, the transmit delay time value may be included in LPP messages, or may be transferred via RRC. MAC-CE, DCI, or other signaling protocols.

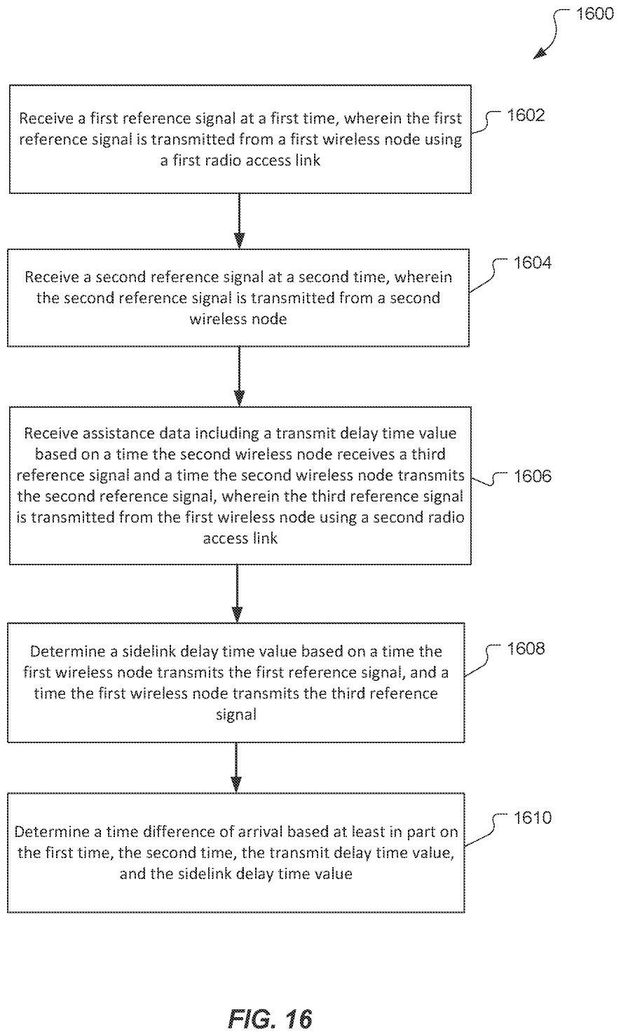

Referring to FIG. 16, with further reference to FIGS. 1-13, a method 1600 of determining a time difference of arrival in sidelink aided uplink positioning includes the stages shown. The method 1600 is, however, an example and not limiting. The method 1600 may be altered, e.g., by having stages added, removed, rearranged, combined, performed concurrently, and/or having single stages split into multiple stages.

At stage 1602, the method includes receiving a first reference signal at a first time, wherein the first reference signal is transmitted from a first wireless node using a first radio access link. A TRP 300, including the transceiver 315 and the processor 310, is a means for receiving the first reference signal. In an embodiment, the first reference signal may be a UL SRS transmitted from a target UE. For example, referring to FIG. 13, the first reference signal may be the UL SRS 1318 transmitted by the target UE 1202 and received by the gNB 1208. The first radio access link may utilize a WAN technology such as LTE, 5G NR or other RATs as described in FIG. 1. Other reference signals (e.g., NRS. TRS, CRS, etc.) may be transmitted from other wireless nodes and received by a station such as the gNB 1208. The first time may be the time of arrival of the first reference signal at the gNB (e.g., time T8 as depicted in FIG. 11).

At stage 1604, the method includes receiving a second reference signal at a second time, wherein the second reference signal is transmitted from a second wireless node. The TRP 300, including the transceiver 315 and the processor 310, is a means for receiving the second reference signal. In an embodiment, the second reference signal may be a UL SRS transmitted from a cooperating UE. For example, referring to FIG. 13, the second reference signal may be the UL SRS 1322a transmitted by the first cooperating UE 1204 and received by the gNB 1208. The second reference signal may utilize the first radio access link, and may be an UL SRS or other reference signals (e.g., NRS, TRS, CRS, etc.) which may be transmitted from wireless nodes that are proximate to the target UE which transmitted the first reference signal. For example, in a V2X network, the second wireless node may be a Roadside Unit (RSU) configured to communicate with a base station (e.g., via a Uu interface) and with proximate UEs via a sidelink (e.g., a PC5 interface). The second time may be the time of arrival of the second reference signal at the gNB (e.g., time T9 as depicted in FIG. 11).

At stage 1606, the method includes receiving assistance data including a transmit delay time value based on a time the second wireless node receives a third reference signal and a time the second wireless node transmits the second reference signal, wherein the third reference signal is transmitted from the first wireless node using a second radio access link. The TRP 300, including the transceiver 315 and the processor 310, is a means for receiving the assistance data. In an embodiment, referring to FIG. 13, the third reference signal may be the first sidelink signal 1316a transmitted by the target UE 1202 and received by the first cooperating UE 1204. The second radio access link may be based on a sidelink protocol and may utilize a sidelink channel (e.g., PSCCH. PSSCH, or other sidelink channels). In an example, the third reference signal may be a CSI-RS configured within the PSSCH transmission. The transmit delay time value in the assistance data may be the Rx-Tx delay message 1322c indicating the Rx-Tx delay value 1102. In an embodiment, the LMF 1210 may be configured to provide the Rx-Tx delay value to the gNB 1208.

At stage 1608, the method includes determining a sidelink delay time value based on a time the first wireless node transmits the first reference signal, and a time the first wireless node transmits the third reference signal. The TRP 300, including the transceiver 315 and the processor 310, is a means for determining the sidelink delay time value. In an embodiment, the sidelink delay time value is based on a delta SRS-sidelink value included in a delta SRS-sidelink reporting message 1320 received from the target UE 1202. For example, referring to FIG. 11, the sidelink delay time value may be the delta SRS-sidelink value 1106a (i.e., T4-T1) based on the time difference between transmitting the first sidelink signal 1012 and the UL SRS 1010. In an embodiment, the sidelink delay time value may be based on a sidelink grant and the gNB 1208 may be configured to determine the sidelink delay value based on the grant information. In an example, the LMF 1210 may provide an indication of the sidelink delay time value to the gNB 1208 in a positioning message.

At stage 1610, the method includes determining a time difference of arrival based at least in part on the first time, the second time, the transmit delay time value, and the sidelink delay time value. The TRP 300, including the processor 310, is a means for determining the time difference of arrival. In an embodiment, the gNB 1208 may be configured to determine a time difference of arrival such as the RSTD in equations (6) and (7). For example, the T8 value may be the first time determined at stage 1602, and the T9 value may be the second time determined at stage 1604. The T6-T3 (i.e., Rx-Tx delay) may be the transmit delay time received at stage 1606, and the [delta SRS-sidelink] value may be the sidelink delay time value determined at stage 1608. The estimated propagation time (i.e., T9-T6) may be provided by the LMF 1210, or may be measured based on an RTT or other NR measurement with the second wireless node. In an example, the location of the second wireless node may be known (e.g., via satellite navigation or other precise point navigation method) and the propagation time may be estimated based on the range to the second wireless node. The method 1600 provides the technical advantage of obtaining uplink based RSTD values without the need for a synchronized time between the wireless nodes. The resulting RSTD valued may be used in mutlilateration positioning methods such as described in FIG. 5. Other positioning methods may also be used.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an.” and “the” include the plural forms as well, unless the context clearly indicates otherwise. The terms “comprises.” “comprising.” “includes.” and/or “including,” as used herein, specify the presence of stated features, integers, steps, operations, elements, and/or components, but do not preclude the presence or addition of one or more other features, integers, steps, operations, elements, components, and/or groups thereof.

As used herein, the term RS (reference signal) may refer to one or more reference signals and may apply, as appropriate, to any form of the term RS, e.g., PRS, SRS, CSI-RS, etc.

As used herein, unless otherwise stated, a statement that a function or operation is “based on” an item or condition means that the function or operation is based on the stated item or condition and may be based on one or more items and/or conditions in addition to the stated item or condition.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B means that the item may be configured to perform the function regarding A, or may be configured to perform the function regarding B. or may be configured to perform the function regarding A and B. For example, a phrase of “a processor configured to measure at least one of A or B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item. e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium.” “machine-readable medium,” and “computer-readable medium.” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method of determining a time difference of arrival value, comprising: receiving a first reference signal at a first time, wherein the first reference signal is transmitted from a first wireless node using a first radio access link; receiving a second reference signal at a second time, wherein the second reference signal is transmitted from a second wireless node using a second radio access link; receiving assistance data including at least a transmit delay time value based on a time the first reference signal is received by the second wireless node, and a time the second reference signal is transmitted by the second wireless node; and determining the time difference of arrival value based at least in part on the first time, the second time and the transmit delay time value.

Clause 2. The method of clause 1 wherein the first wireless node is a base station and the first reference signal is a downlink positioning reference signal.

Clause 3. The method of clause 1 wherein the second wireless node is a user equipment and the second reference signal is sidelink reference signal.

Clause 4. The method of clause 1 wherein the first radio access link utilizes a cellular wide area network technology, and the second radio access link is based on a sidelink protocol.

Clause 5. The method of clause 4 wherein the cellular wide area network technology includes fifth generation new radio.

Clause 6. The method of clause 1 wherein receiving the assistance data includes receiving one or more sidelink messages including the assistance data from the second wireless node.

Clause 7. The method of clause 1 wherein receiving the assistance data includes receiving one or more messages including the assistance data from the first wireless node.

Clause 8. The method of clause 1 wherein the assistance data includes an estimated propagation time based on a distance between the first wireless node and the second wireless node, and determining the time difference of arrival value is based at least in part on the estimated propagation time.

Clause 9. The method of clause 1 further comprising determining a location based at least in part on the time difference of arrival value.

Clause 10. A method of providing sidelink assistance data, comprising: receiving a first reference signal at a first time, wherein the first reference signal is transmitted from a first wireless node using a first radio access link; transmitting a second reference signal at a second time using a second radio access link; determining a transmit delay time value based on the first time and the second time; and transmitting an indication of the transmit delay time value.

Clause 11. The method of clause 10 wherein the first wireless node is a base station and the first reference signal is a downlink positioning reference signal.

Clause 12. The method of clause 10 wherein the second reference signal is sidelink reference signal.

Clause 13. The method of clause 10 wherein the first wireless node is a user equipment and the first reference signal is a sidelink reference signal.

Clause 14. The method of clause 10 wherein the second reference signal is an uplink sounding reference signal.

Clause 15. The method of clause 10 wherein the first radio access link utilizes a cellular wide area network technology, and the second radio access link is based on a sidelink protocol.

Clause 16. The method of clause 15 wherein the cellular wide area network technology includes fifth generation new radio.

Clause 17. The method of clause 10 wherein transmitting the indication of the transmit delay time value includes transmitting one or more sidelink messages including the transmit delay time value to a proximate user equipment.

Clause 18. The method of clause 10 wherein transmitting the indication of the transmit delay time value includes transmitting one or more uplink messages including the transmit delay time value to a base station.

Clause 19. A method of determining a time difference of arrival value, comprising: receiving a first reference signal at a first time, wherein the first reference signal is transmitted from a first wireless node using a first radio access link; receiving a second reference signal at a second time, wherein the second reference signal is transmitted from a second wireless node; receiving assistance data including a transmit delay time value based on a time the second wireless node receives a third reference signal and a time the second wireless node transmits the second reference signal, wherein the third reference signal is transmitted from the first wireless node using a second radio access link; determining a sidelink delay time value based on a time the first wireless node transmits the first reference signal, and a time the first wireless node transmits the third reference signal; and determining the time difference of arrival value based at least in part on the first time, the second time, the transmit delay time value, and the sidelink delay time value.

Clause 20. The method of clause 19 wherein the first wireless node is a user equipment and the first reference signal is an uplink positioning reference signal.

Clause 21. The method of clause 19 wherein the second wireless node is a user equipment and the second reference signal is an uplink positioning reference signal.

Clause 22. The method of clause 19 wherein the third reference signal is a sidelink reference signal.

Clause 23. The method of clause 19 wherein the first radio access link utilizes a cellular wide area network technology, and the second radio access link is based on a sidelink protocol.

Clause 24. The method of clause 23 wherein the cellular wide area network technology includes fifth generation new radio.

Clause 25. The method of clause 19 wherein receiving the assistance data includes receiving one or more sidelink messages including the assistance data from the second wireless node.

Clause 26. The method of clause 19 wherein receiving the assistance data includes receiving one or more messages including the assistance data from a network server.

Clause 27. The method of clause 19 wherein determining the sidelink delay time value includes receiving one or more messages from the first wireless node.

Clause 28. The method of clause 19 wherein determining the sidelink delay time value includes receiving one or more messages from a network server.

Clause 29. The method of clause 19 further comprising determining a range to the second wireless node.

Clause 30. The method of clause 19 further comprising determining a location of the first wireless node based at least in part on the time difference of arrival value.

Clause 31. An apparatus, comprising: a memory; at least one transceiver; at least one processor communicatively coupled to the memory and the at least one transceiver, and configured to: receive a first reference signal at a first time, wherein the first reference signal is transmitted from a first wireless node using a first radio access link; receive a second reference signal at a second time, wherein the second reference signal is transmitted from a second wireless node using a second radio access link; receive assistance data including at least a transmit delay time value based on a time the first reference signal is received by the second wireless node, and a time the second reference signal is transmitted by the second wireless node; and determine a time difference of arrival value based at least in part on the first time, the second time and the transmit delay time value.

Clause 32. The apparatus of clause 31 wherein the first wireless node is a base station and the first reference signal is a downlink positioning reference signal.

Clause 33. The apparatus of clause 31 wherein the second wireless node is a user equipment and the second reference signal is sidelink reference signal.

Clause 34. The apparatus of clause 31 wherein the first radio access link utilizes a cellular wide area network technology, and the second radio access link is based on a sidelink protocol.

Clause 35. The apparatus of clause 34 wherein the cellular wide area network technology includes fifth generation new radio.

Clause 36. The apparatus of clause 31 wherein the at least one processor is further configured to receive one or more sidelink messages including the assistance data from the second wireless node.

Clause 37. The apparatus of clause 31 wherein the at least one processor is further configured to receive one or more messages including the assistance data from the first wireless node.

Clause 38. The apparatus of clause 31 wherein the assistance data includes an estimated propagation time based on a distance between the first wireless node and the second wireless node, and the at least one processor is further configured to determine the time difference of arrival value is based at least in part on the estimated propagation time.

Clause 39. The apparatus of clause 31 wherein the at least one processor is further configured to determine a location based at least in part on the time difference of arrival value.

Clause 40. An apparatus, comprising: a memory; at least one transceiver; at least one processor communicatively coupled to the memory and the at least one transceiver, and configured to: receive a first reference signal at a first time, wherein the first reference signal is transmitted from a first wireless node using a first radio access link; transmit a second reference signal at a second time using a second radio access link; determine a transmit delay time value based on the first time and the second time; and transmit an indication of the transmit delay time value.

Clause 41. The apparatus of clause 40 wherein the first wireless node is a base station and the first reference signal is a downlink positioning reference signal.

Clause 42. The apparatus of clause 40 wherein the second reference signal is sidelink reference signal.

Clause 43. The apparatus of clause 40 wherein the first wireless node is a user equipment and the first reference signal is a sidelink reference signal.

Clause 44. The apparatus of clause 40 wherein the second reference signal is an uplink sounding reference signal.

Clause 45. The apparatus of clause 40 wherein the first radio access link utilizes a cellular wide area network technology, and the second radio access link is based on a sidelink protocol.

Clause 46. The apparatus of clause 45 wherein the cellular wide area network technology includes fifth generation new radio.

Clause 47. The apparatus of clause 40 wherein the at least one processor is further configured to transmitting one or more sidelink messages including the transmit delay time value to a proximate user equipment.

Clause 48. The apparatus of clause 40 wherein the at least one processor is further configured to transmit one or more uplink messages including the transmit delay time value to a base station.

Clause 49. An apparatus, comprising: a memory; at least one transceiver, at least one processor communicatively coupled to the memory and the at least one transceiver, and configured to: receive a first reference signal at a first time, wherein the first reference signal is transmitted from a first wireless node using a first radio access link; receive a second reference signal at a second time, wherein the second reference signal is transmitted from a second wireless node; receive assistance data including a transmit delay time value based on a time the second wireless node receives a third reference signal and a time the second wireless node transmits the second reference signal, wherein the third reference signal is transmitted from the first wireless node using a second radio access link; determine a sidelink delay time value based on a time the first wireless node transmits the first reference signal, and a time the first wireless node transmits the third reference signal; and determine a time difference of arrival value based at least in part on the first time, the second time, the transmit delay time value, and the sidelink delay time value.

Clause 50. The apparatus of clause 49 wherein the first wireless node is a user equipment and the first reference signal is an uplink positioning reference signal.

Clause 51. The apparatus of clause 49 wherein the second wireless node is a user equipment and the second reference signal is an uplink positioning reference signal.

Clause 52. The apparatus of clause 49 wherein the third reference signal is a sidelink reference signal.

Clause 53. The apparatus of clause 49 wherein the first radio access link utilizes a cellular wide area network technology, and the second radio access link is based on a sidelink protocol.

Clause 54. The apparatus of clause 53 wherein the cellular wide area network technology includes fifth generation new radio.

Clause 55. The apparatus of clause 49 wherein the at least one processor is further configured to receive one or more sidelink messages including the assistance data from the second wireless node.

Clause 56. The apparatus of clause 49 wherein the at least one processor is further configured to receive one or more messages including the assistance data from a network server.

Clause 57. The apparatus of clause 49 wherein the at least one processor is further configured to receive one or more messages from the first wireless node to determine the sidelink delay time value.

Clause 58. The apparatus of clause 49 wherein the at least one processor is further configured to receive one or more messages from a network server to determine the sidelink delay time value.

Clause 59. The apparatus of clause 49 wherein the at least one processor is further configured to determine a range to the second wireless node.

Clause 60. The apparatus of clause 49 wherein the at least one processor is further configured to determine a location of the first wireless node based at least in part on the time difference of arrival value.

Clause 61. An apparatus for determining a time difference of arrival value, comprising: means for receiving a first reference signal at a first time, wherein the first reference signal is transmitted from a first wireless node using a first radio access link; means for receiving a second reference signal at a second time, wherein the second reference signal is transmitted from a second wireless node using a second radio access link; means for receiving assistance data including at least a transmit delay time value based on a time the first reference signal is received by the second wireless node, and a time the second reference signal is transmitted by the second wireless node; and means for determining the time difference of arrival value based at least in part on the first time, the second time and the transmit delay time value.

Clause 62. An apparatus for providing sidelink assistance data, comprising: means for receiving a first reference signal at a first time, wherein the first reference signal is transmitted from a first wireless node using a first radio access link; means for transmitting a second reference signal at a second time using a second radio access link; means for determining a transmit delay time value based on the first time and the second time; and means for transmitting an indication of the transmit delay time value.

Clause 63. An apparatus for determining a time difference of arrival value, comprising: means for receiving a first reference signal at a first time, wherein the first reference signal is transmitted from a first wireless node using a first radio access link; means for receiving a second reference signal at a second time, wherein the second reference signal is transmitted from a second wireless node; means for receiving assistance data including a transmit delay time value based on a time the second wireless node receives a third reference signal and a time the second wireless node transmits the second reference signal, wherein the third reference signal is transmitted from the first wireless node using a second radio access link; means for determining a sidelink delay time value based on a time the first wireless node transmits the first reference signal, and a time the first wireless node transmits the third reference signal; and means for determining the time difference of arrival value based at least in part on the first time, the second time, the transmit delay time value, and the sidelink delay time value.

Clause 64. A non-transitory processor-readable storage medium comprising processor-readable instructions configured to cause one or more processors to determine a time difference of arrival value, comprising: code for receiving a first reference signal at a first time, wherein the first reference signal is transmitted from a first wireless node using a first radio access link; code for receiving a second reference signal at a second time, wherein the second reference signal is transmitted from a second wireless node using a second radio access link; code for receiving assistance data including at least a transmit delay time value based on a time the first reference signal is received by the second wireless node, and a time the second reference signal is transmitted by the second wireless node; and code for determining the time difference of arrival value based at least in part on the first time, the second time and the transmit delay time value.

Clause 65. A non-transitory processor-readable storage medium comprising processor-readable instructions configured to cause one or more processors to provide sidelink assistance data, comprising: code for receiving a first reference signal at a first time, wherein the first reference signal is transmitted from a first wireless node using a first radio access link; code for transmitting a second reference signal at a second time using a second radio access link; code for determining a transmit delay time value based on the first time and the second time; and code for transmitting an indication of the transmit delay time value.

Clause 66. A non-transitory processor-readable storage medium comprising processor-readable instructions configured to cause one or more processors to determine a time difference of arrival value, comprising: code for receiving a first reference signal at a first time, wherein the first reference signal is transmitted from a first wireless node using a first radio access link; code for receiving a second reference signal at a second time, wherein the second reference signal is transmitted from a second wireless node; code for receiving assistance data including a transmit delay time value based on a time the second wireless node receives a third reference signal and a time the second wireless node transmits the second reference signal, wherein the third reference signal is transmitted from the first wireless node using a second radio access link; code for determining a sidelink delay time value based on a time the first wireless node transmits the first reference signal, and a time the first wireless node transmits the third reference signal, and code for determining a time difference of arrival based at least in part on the first time, the second time, the transmit delay time value, and the sidelink delay time value.

1. A method of determining a time difference of arrival value, comprising:
receiving a first reference signal at a first time, wherein the first reference signal is transmitted from a first wireless node using a first radio access link;
receiving a second reference signal at a second time, wherein the second reference signal is transmitted from a second wireless node using a second radio access link;
receiving assistance data including at least a transmit delay time value based on a time the first reference signal is received by the second wireless node, and a time the second reference signal is transmitted by the second wireless node; and
determining the time difference of arrival value based at least in part on the first time, the second time and the transmit delay time value.

2. The method of claim 1 wherein the first wireless node is a base station and the first reference signal is a downlink positioning reference signal.

3. The method of claim 1 wherein the second wireless node is a user equipment and the second reference signal is sidelink reference signal.

4. The method of claim 1 wherein the first radio access link utilizes a cellular wide area network technology, and the second radio access link is based on a sidelink protocol.

5. The method of claim 4 wherein the cellular wide area network technology includes fifth generation new radio.

6. The method of claim 1 wherein receiving the assistance data includes receiving one or more sidelink messages including the assistance data from the second wireless node.

7. The method of claim 1 wherein receiving the assistance data includes receiving one or more messages including the assistance data from the first wireless node.

8. The method of claim 1 wherein the assistance data includes an estimated propagation time based on a distance between the first wireless node and the second wireless node, and determining the time difference of arrival value is based at least in part on the estimated propagation time.

9. The method of claim 1 further comprising determining a location based at least in part on the time difference of arrival value.

10. A method of providing sidelink assistance data, comprising:
receiving a first reference signal at a first time, wherein the first reference signal is transmitted from a first wireless node using a first radio access link;
transmitting a second reference signal at a second time using a second radio access link;
determining a transmit delay time value based on the first time and the second time; and
transmitting an indication of the transmit delay time value.

11. The method of claim 10 wherein the first wireless node is a base station and the first reference signal is a downlink positioning reference signal.

12. The method of claim 10 wherein the second reference signal is sidelink reference signal.

13. The method of claim 10 wherein the first wireless node is a user equipment and the first reference signal is a sidelink reference signal.

14. The method of claim 10 wherein the second reference signal is an uplink sounding reference signal.

15. The method of claim 10 wherein the first radio access link utilizes a cellular wide area network technology, and the second radio access link is based on a sidelink protocol.

16. The method of claim 15 wherein the cellular wide area network technology includes fifth generation new radio.

17. The method of claim 10 wherein transmitting the indication of the transmit delay time value includes transmitting one or more sidelink messages including the transmit delay time value to a proximate user equipment.

18. The method of claim 10 wherein transmitting the indication of the transmit delay time value includes transmitting one or more uplink messages including the transmit delay time value to a base station.

19. A method of determining a time difference of arrival value, comprising:
receiving a first reference signal at a first time, wherein the first reference signal is transmitted from a first wireless node using a first radio access link;
receiving a second reference signal at a second time, wherein the second reference signal is transmitted from a second wireless node;
receiving assistance data including a transmit delay time value based on a time the second wireless node receives a third reference signal and a time the second wireless node transmits the second reference signal, wherein the third reference signal is transmitted from the first wireless node using a second radio access link;
determining a sidelink delay time value based on a time the first wireless node transmits the first reference signal, and a time the first wireless node transmits the third reference signal; and
determining the time difference of arrival value based at least in part on the first time, the second time, the transmit delay time value, and the sidelink delay time value.

20. The method of claim 19 wherein the first wireless node is a user equipment and the first reference signal is an uplink positioning reference signal.

21. The method of claim 19 wherein the second wireless node is a user equipment and the second reference signal is an uplink positioning reference signal.

22. The method of claim 19 wherein the third reference signal is a sidelink reference signal.

23. The method of claim 19 wherein the first radio access link utilizes a cellular wide area network technology, and the second radio access link is based on a sidelink protocol.

24. The method of claim 23 wherein the cellular wide area network technology includes fifth generation new radio.

25. The method of claim 19 wherein receiving the assistance data includes receiving one or more sidelink messages including the assistance data from the second wireless node.

26. The method of claim 19 wherein receiving the assistance data includes receiving one or more messages including the assistance data from a network server.

27. The method of claim 19 wherein determining the sidelink delay time value includes receiving one or more messages from the first wireless node.

28. The method of claim 19 wherein determining the sidelink delay time value includes receiving one or more messages from a network server.

29. The method of claim 19 further comprising determining a range to the second wireless node.

30. The method of claim 19 further comprising determining a location of the first wireless node based at least in part on the time difference of arrival value.

31. An apparatus, comprising:
a memory;
at least one transceiver;
at least one processor communicatively coupled to the memory and the at least one transceiver, and configured to:
receive a first reference signal at a first time, wherein the first reference signal is transmitted from a first wireless node using a first radio access link;
receive a second reference signal at a second time, wherein the second reference signal is transmitted from a second wireless node using a second radio access link;
receive assistance data including at least a transmit delay time value based on a time the first reference signal is received by the second wireless node, and a time the second reference signal is transmitted by the second wireless node; and
determine a time difference of arrival value based at least in part on the first time, the second time and the transmit delay time value.

32. The apparatus of claim 31 wherein the first wireless node is a base station and the first reference signal is a downlink positioning reference signal.

33. The apparatus of claim 31 wherein the second wireless node is a user equipment and the second reference signal is sidelink reference signal.

34. The apparatus of claim 31 wherein the first radio access link utilizes a cellular wide area network technology, and the second radio access link is based on a sidelink protocol.

35. The apparatus of claim 34 wherein the cellular wide area network technology includes fifth generation new radio.

36. The apparatus of claim 31 wherein the at least one processor is further configured to receive one or more sidelink messages including the assistance data from the second wireless node.

37. The apparatus of claim 31 wherein the at least one processor is further configured to receive one or more messages including the assistance data from the first wireless node.

38. The apparatus of claim 31 wherein the assistance data includes an estimated propagation time based on a distance between the first wireless node and the second wireless node, and the at least one processor is further configured to determine the time difference of arrival value is based at least in part on the estimated propagation time.

39. The apparatus of claim 31 wherein the at least one processor is further configured to determine a location based at least in part on the time difference of arrival value.

40. An apparatus, comprising:
a memory;
at least one transceiver;
at least one processor communicatively coupled to the memory and the at least one transceiver, and configured to:
receive a first reference signal at a first time, wherein the first reference signal is transmitted from a first wireless node using a first radio access link;
transmit a second reference signal at a second time using a second radio access link;
determine a transmit delay time value based on the first time and the second time; and
transmit an indication of the transmit delay time value.

41. The apparatus of claim 40 wherein the first wireless node is a base station and the first reference signal is a downlink positioning reference signal.

42. The apparatus of claim 40 wherein the second reference signal is sidelink reference signal.

43. The apparatus of claim 40 wherein the first wireless node is a user equipment and the first reference signal is a sidelink reference signal.

44. The apparatus of claim 40 wherein the second reference signal is an uplink sounding reference signal.

45. The apparatus of claim 40 wherein the first radio access link utilizes a cellular wide area network technology, and the second radio access link is based on a sidelink protocol.

46. The apparatus of claim 45 wherein the cellular wide area network technology includes fifth generation new radio.

47. The apparatus of claim 40 wherein the at least one processor is further configured to transmitting one or more sidelink messages including the transmit delay time value to a proximate user equipment.

48. The apparatus of claim 40 wherein the at least one processor is further configured to transmit one or more uplink messages including the transmit delay time value to a base station.

49. An apparatus, comprising:
a memory;
at least one transceiver;
at least one processor communicatively coupled to the memory and the at least one transceiver, and configured to:
receive a first reference signal at a first time, wherein the first reference signal is transmitted from a first wireless node using a first radio access link;
receive a second reference signal at a second time, wherein the second reference signal is transmitted from a second wireless node;
receive assistance data including a transmit delay time value based on a time the second wireless node receives a third reference signal and a time the second wireless node transmits the second reference signal, wherein the third reference signal is transmitted from the first wireless node using a second radio access link;
determine a sidelink delay time value based on a time the first wireless node transmits the first reference signal, and a time the first wireless node transmits the third reference signal; and
determine a time difference of arrival value based at least in part on the first time, the second time, the transmit delay time value, and the sidelink delay time value.

50. The apparatus of claim 49 wherein the first wireless node is a user equipment and the first reference signal is an uplink positioning reference signal.

51. The apparatus of claim 49 wherein the second wireless node is a user equipment and the second reference signal is an uplink positioning reference signal.

52. The apparatus of claim 49 wherein the third reference signal is a sidelink reference signal.

53. The apparatus of claim 49 wherein the first radio access link utilizes a cellular wide area network technology, and the second radio access link is based on a sidelink protocol.

54. The apparatus of claim 53 wherein the cellular wide area network technology includes fifth generation new radio.

55. The apparatus of claim 49 wherein the at least one processor is further configured to receive one or more sidelink messages including the assistance data from the second wireless node.

56. The apparatus of claim 49 wherein the at least one processor is further configured to receive one or more messages including the assistance data from a network server.

57. The apparatus of claim 49 wherein the at least one processor is further configured to receive one or more messages from the first wireless node to determine the sidelink delay time value.

58. The apparatus of claim 49 wherein the at least one processor is further configured to receive one or more messages from a network server to determine the sidelink delay time value.

59. The apparatus of claim 49 wherein the at least one processor is further configured to determine a range to the second wireless node.

60. The apparatus of claim 49 wherein the at least one processor is further configured to determine a location of the first wireless node based at least in part on the time difference of arrival value.

61. An apparatus for determining a time difference of arrival value, comprising:
means for receiving a first reference signal at a first time, wherein the first reference signal is transmitted from a first wireless node using a first radio access link;
means for receiving a second reference signal at a second time, wherein the second reference signal is transmitted from a second wireless node using a second radio access link;
means for receiving assistance data including at least a transmit delay time value based on a time the first reference signal is received by the second wireless node, and a time the second reference signal is transmitted by the second wireless node; and
means for determining the time difference of arrival value based at least in part on the first time, the second time and the transmit delay time value.

62. An apparatus for providing sidelink assistance data, comprising:
means for receiving a first reference signal at a first time, wherein the first reference signal is transmitted from a first wireless node using a first radio access link;
means for transmitting a second reference signal at a second time using a second radio access link;
means for determining a transmit delay time value based on the first time and the second time; and
means for transmitting an indication of the transmit delay time value.

63. An apparatus for determining a time difference of arrival value, comprising:
means for receiving a first reference signal at a first time, wherein the first reference signal is transmitted from a first wireless node using a first radio access link;
means for receiving a second reference signal at a second time, wherein the second reference signal is transmitted from a second wireless node;
means for receiving assistance data including a transmit delay time value based on a time the second wireless node receives a third reference signal and a time the second wireless node transmits the second reference signal, wherein the third reference signal is transmitted from the first wireless node using a second radio access link;
means for determining a sidelink delay time value based on a time the first wireless node transmits the first reference signal, and a time the first wireless node transmits the third reference signal; and
means for determining the time difference of arrival value based at least in part on the first time, the second time, the transmit delay time value, and the sidelink delay time value.
